(19) United States
(12) Patent Application Publication
(10) Pub. No.: US 2011/0232631 A1
(43) Pub. Date: Sep. 29, 2011

(54) MOSAIC SOLAR COLLECTOR

(76) Inventor: Jon Bøhmer, Thika (KE)

(21) Appl. No.: 12/998,828

(22) PCT Filed: Dec. 8, 2009
(86) PCT No.: PCT/IB2009/007965

§ 371 Date: Jun. 7, 2011

Related U.S. Application Data
(60) Provisional application No. 61/201,195, filed on Dec. 8, 2008.

(51) Int. Cl. F24J 2/54; G02B 5/09; F24J 2/10

(52) U.S. Cl. 126/606; 359/853; 126/684

(57) ABSTRACT

A panel of flat mirrors reflect light towards one or more locations. The light reaching the one or more locations is converted into another form of energy.

### CROSS-REFERENCE TO RELATED APPLICATIONS

This application claims priority benefit of U.S. Provisional Application, Ser. No. 61/201,195 (Docket #65-2), entitled, “Mosaic Solar Collector,” filed Dec. 8, 2008, by Jon Bohmer, which is incorporated herein by reference.

### FIELD

This specification generally relates to solar collectors.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Solar concentrators show great promise, but have not been adopted by the masses of people. Solar concentrators consist of mirrors or lenses, solar cells and tracking mechanisms, and can be made for low, medium, or high concentration. To achieve higher concentrations of light, the systems also require a higher precision tracking and a higher stability. Low concentration devices can in some cases work without tracking. However, tracking is also an advantage, because it can give almost 40% higher energy harvest during the day by directly facing the sun from the morning to the evening. High concentration also requires effective heat dissipation, which can be done passively (heat sinks) or actively (water cooling). Active cooling has an advantage of harvesting the excess heat generated, as many applications can use heated water. High concentration systems use expensive triple-layered cells, which require a concentration of light of over 500 times that of ordinary Sunlight collectors in order to be cost effective. More traditional silicone photo cells can also be used with concentrations from 2-100 times that of ordinary sunlight. Lower concentration solar collectors use more area to collect the same amount of energy as a higher concentration solar collector, but can use simpler tracking and cooling mechanisms.

Current solar technologies such as Photovoltaic (PV) solar cells, which this specification has recognized leaves a lot to be desired in terms of cost, efficiency, utility, and scalability. One problem with solar concentrators is that the PV cells require even illumination across their surface in order to provide maximum energy output and to obtain long life. The degree to which the illumination is even is a function of the optical system. Solar concentrators use either 1D (linear) or 2D (point focus) optics.

Parabolic or Fresnel optics, which can concentrate light to very high ratios of concentration (where ordinary Sunlight is in the denominator of the ratio), may be used for solar concentrators. Fresnel lenses has an advantage over parabolic designs in that a much flatter lens or mirror may be used to obtain the same or a similar concentration of light as a parabolic mirror.

### BRIEF DESCRIPTION

In the following drawings like reference numbers are used to refer to like elements. Although the following figures depict various examples of the invention, the invention is not limited to the examples depicted in the figures.

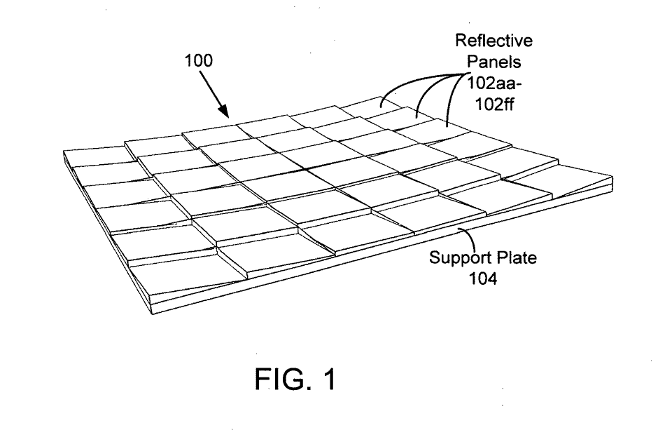

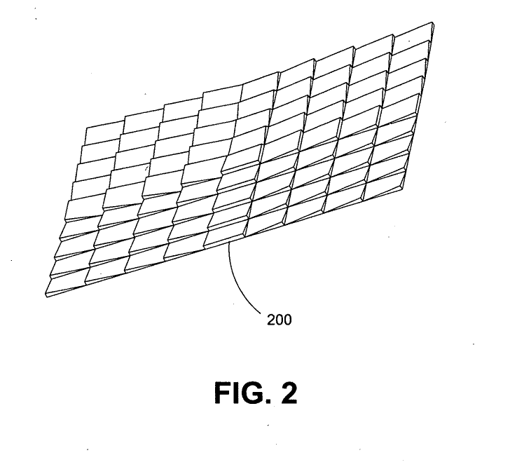

FIGS. 1 and 2 show representations of embodiments of a panel of mirrors (which may also be referred to as a “mosaic”) arranged according to an embodiment of the invention.

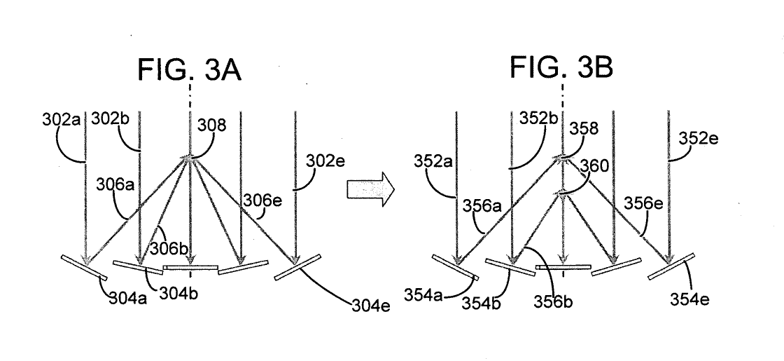

FIG. 3A shows a representation of cross section of an embodiment of a panel or a series of panels of mirrors in which the mirrors are arranged to focus the light to a single point or stated differently to form a single focal point.

FIG. 3B shows a representation of cross section of an embodiment of a panel of mirrors in which the mirrors are arranged to focus the light to multiple points or stated differently to form multiple focal points.

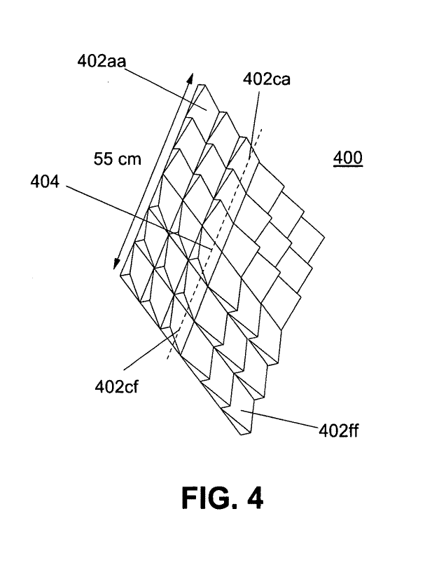

FIG. 4 shows a representation of an embodiment of a square panel of mirrors having 6 mirrors (also called facets) on each side.

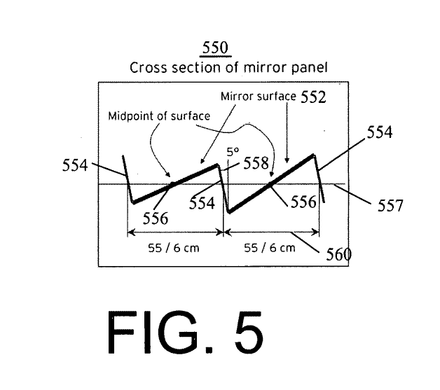

FIG. 5 shows a representation of an embodiment, of a cross section of the square panel of FIG. 4, where the cross section is along the dotted line of FIG. 4.

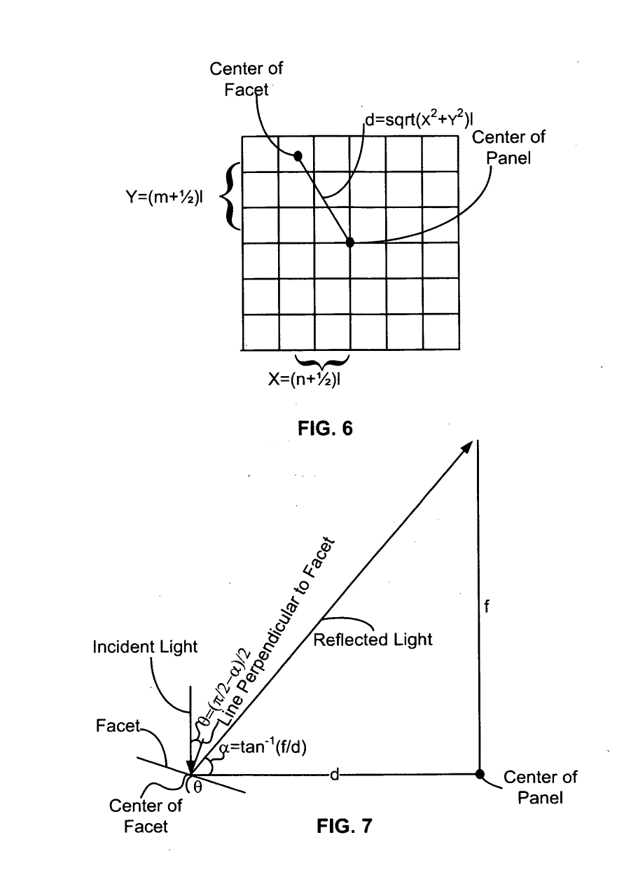

FIG. 6 shows a diagram illustrating the distance from the center of an embodiment of a facet to the center of an embodiment of a panel.

FIG. 7 shows a diagram illustrating the focal length of an embodiment of a panel.

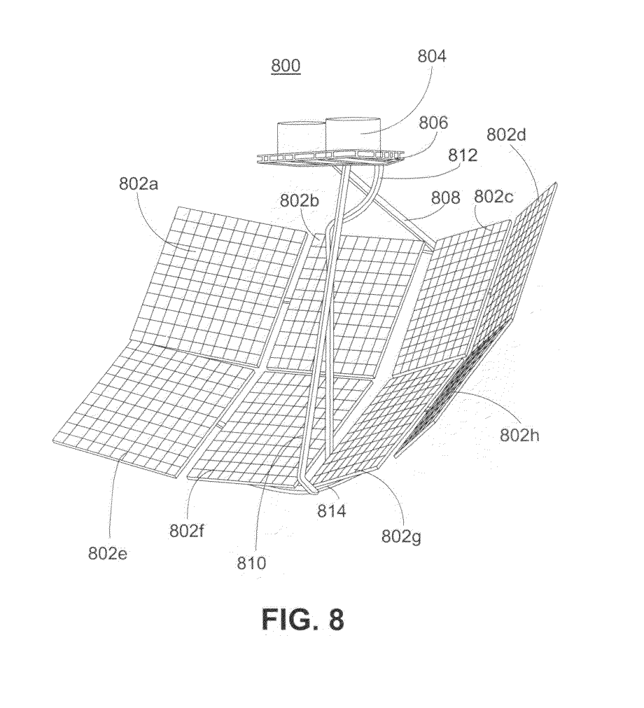

FIG. 8 shows a representation of an embodiment of a solar cooker made from panels of arrays of mirrors (e.g., a polyhedral array).

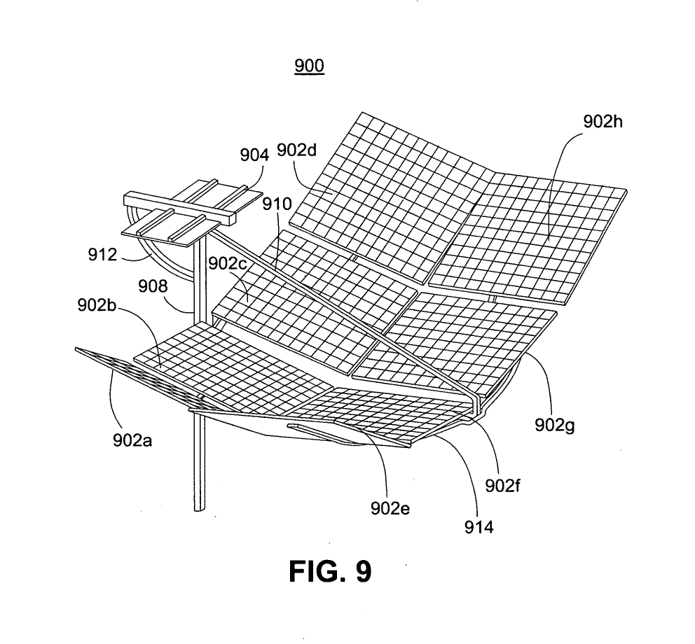

FIG. 9 shows a representation of an embodiment of portable power generator made from panels of arrays of mirrors (e.g., a polyhedral array).

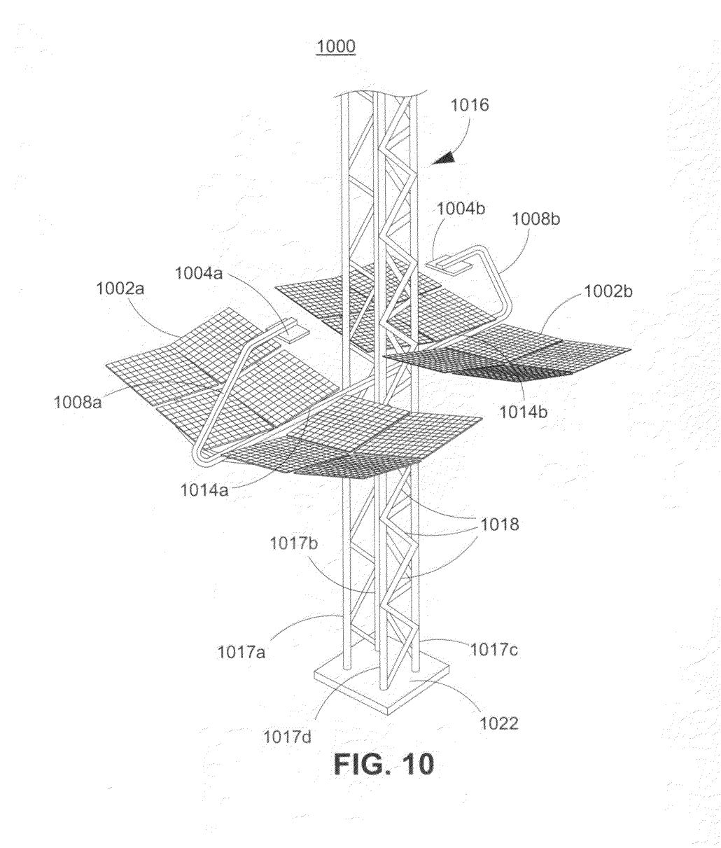

FIG. 10 shows a representation of an embodiment of solar collector that is tower mounted (e.g., a polyhedral array).

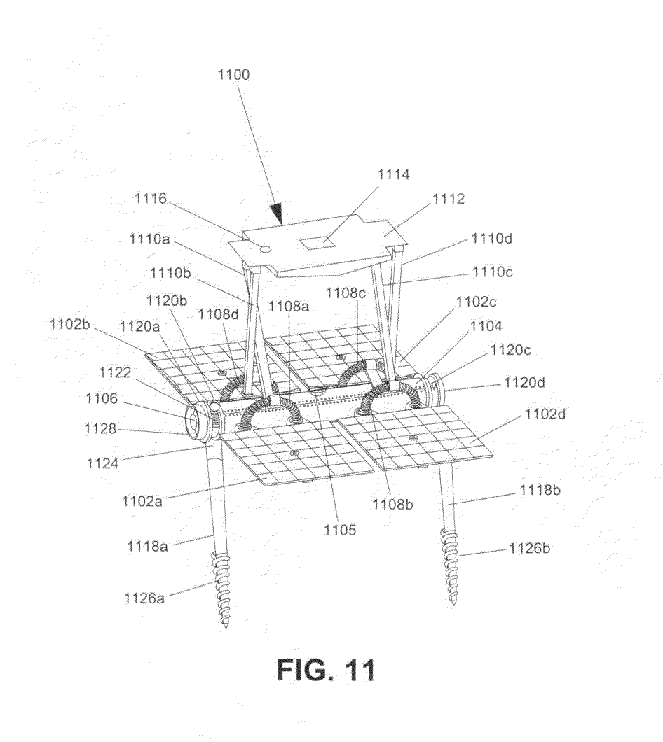

FIG. 11 shows a top view of an embodiment of a solar generator.

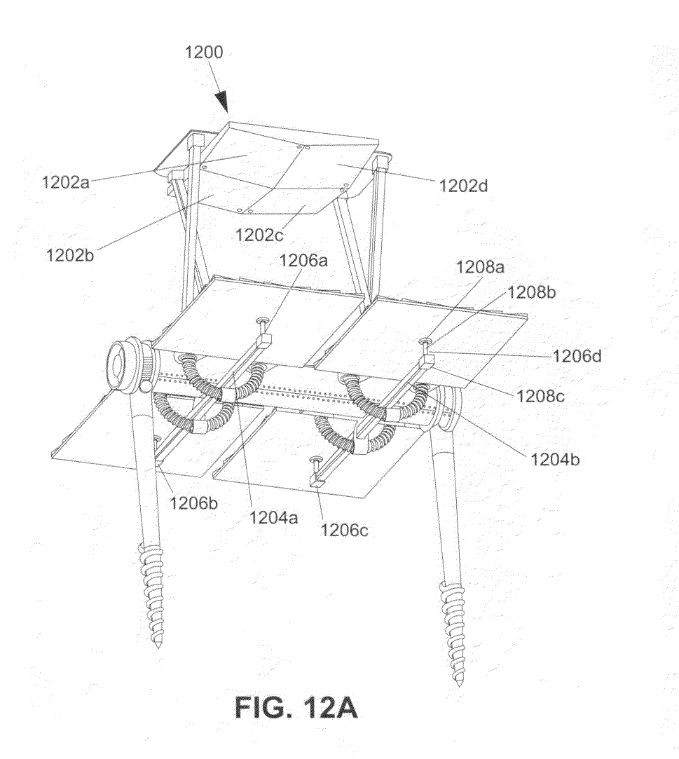

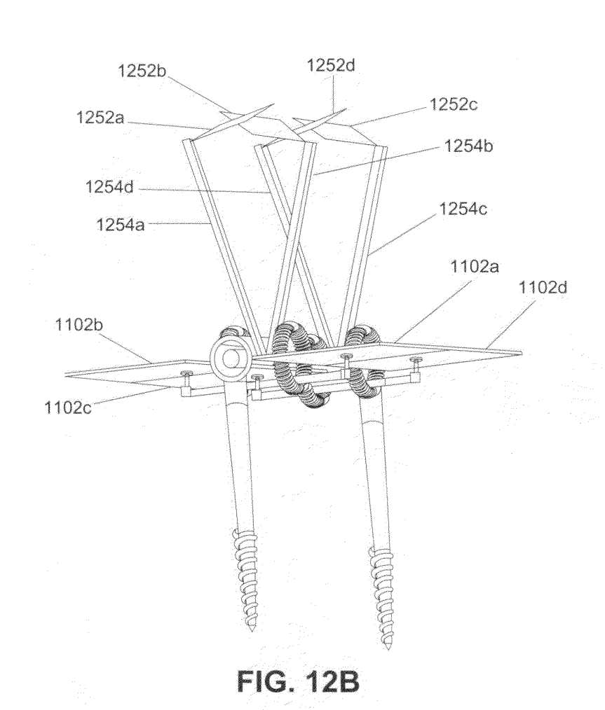

FIG. 12A shows an embodiment of a bottom view of the solar generator of FIG. 11.

FIG. 12B shows an embodiment of a solar generator.

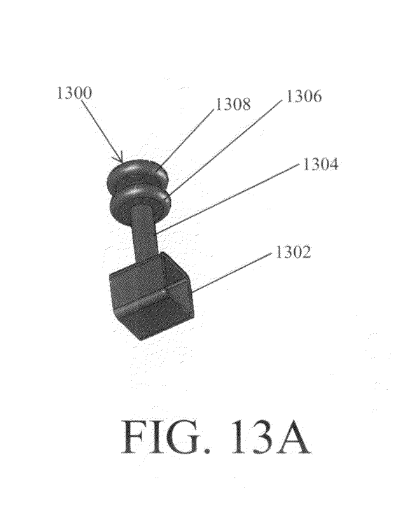

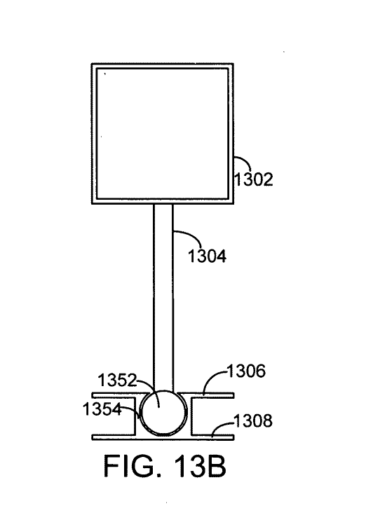

FIG. 13A is an embodiment of the support mount of FIG. 11.

FIG. 13B is a cross section of an embodiment of the support mount of FIG. 13A.

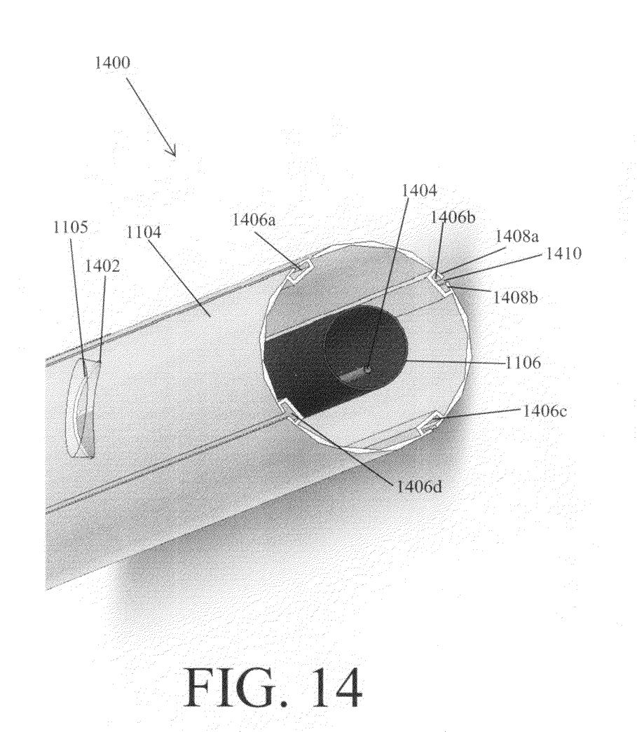

FIG. 14 shows an embodiment of a portion of the solar generator of FIG. 11.

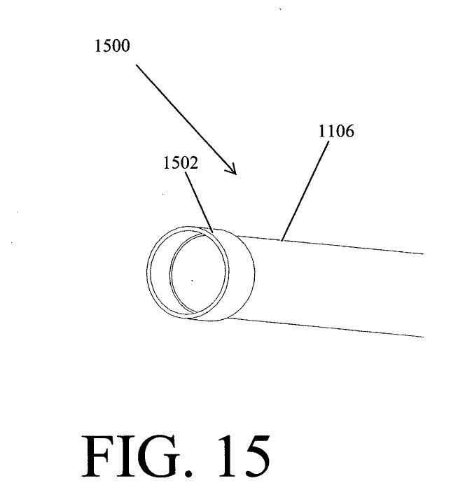

FIG. 15 shows an embodiment of the inner cylinder with the inner collar of FIG. 11.

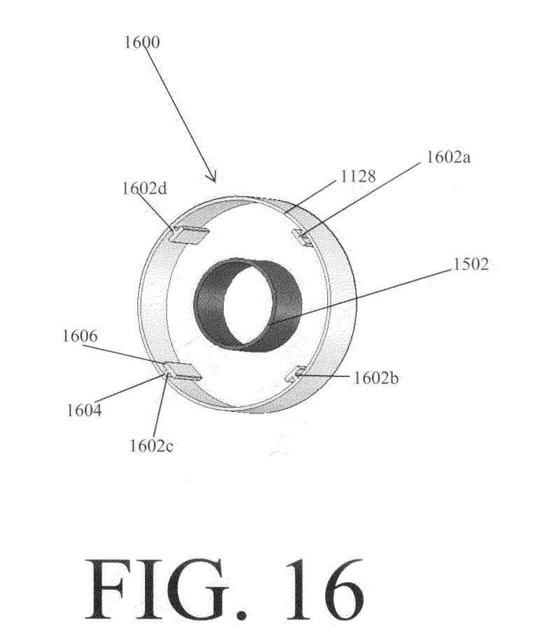

FIG. 16 shows an embodiment of the inner collar and outer collar of the solar generator of FIG. 11.

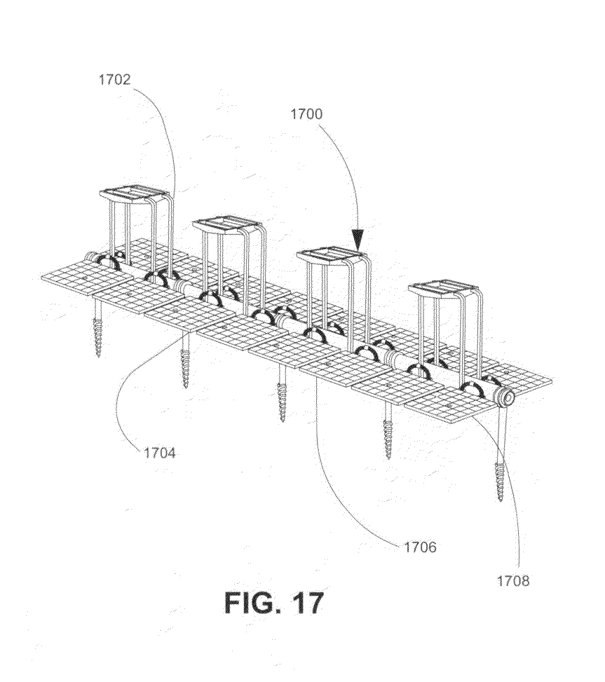

FIG. 17 shows an embodiment of linked solar generators.

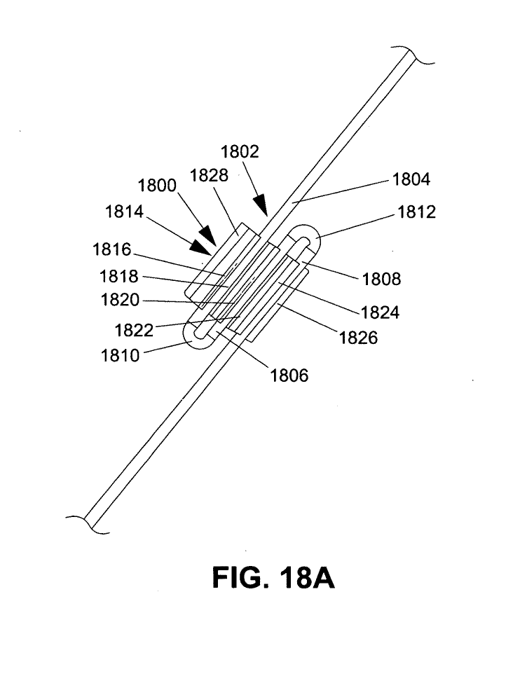

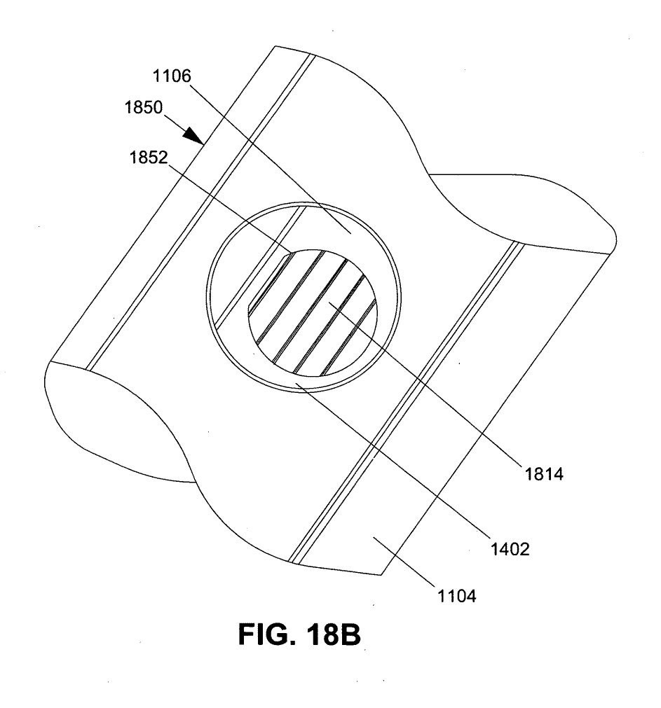

FIG. 18A shows an embodiment of a receiver.

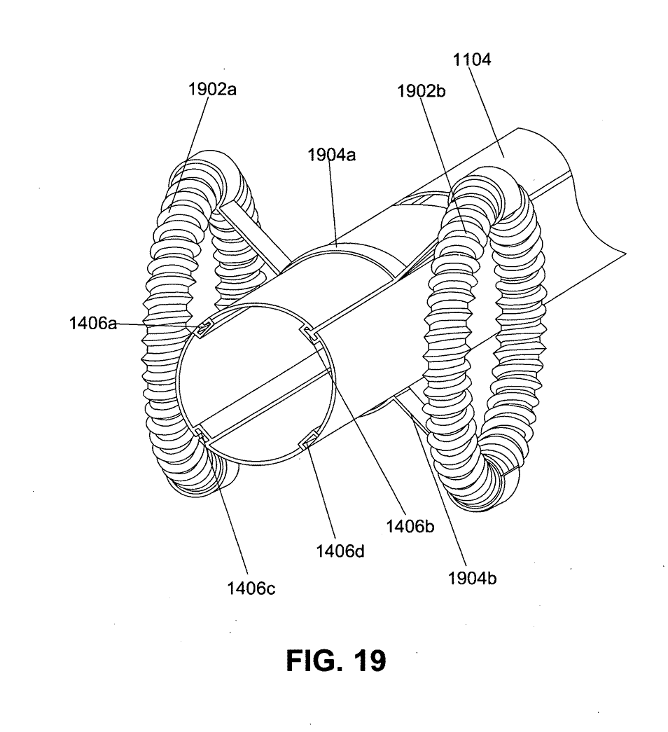

FIG. 19 shows an embodiment of a portion of solar generator of FIG. 11.

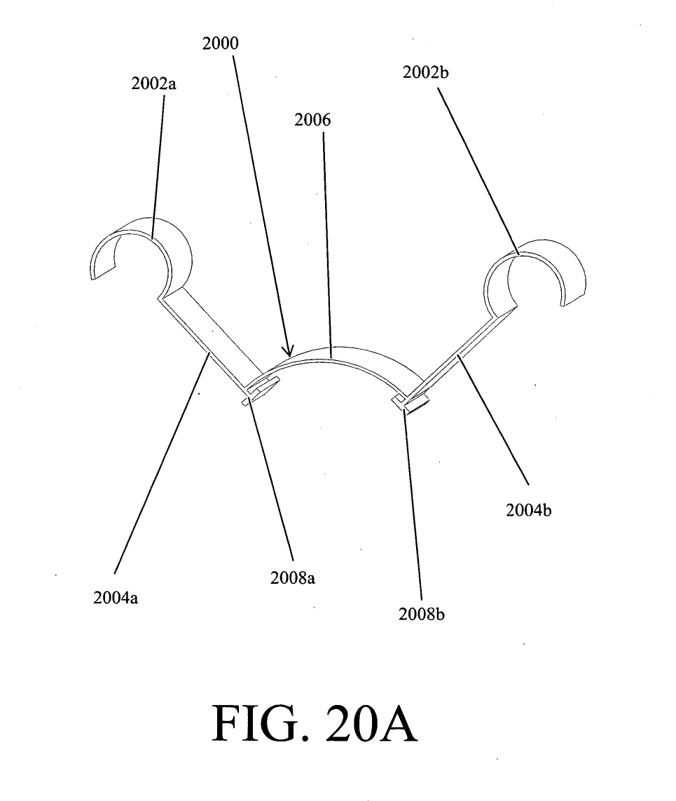

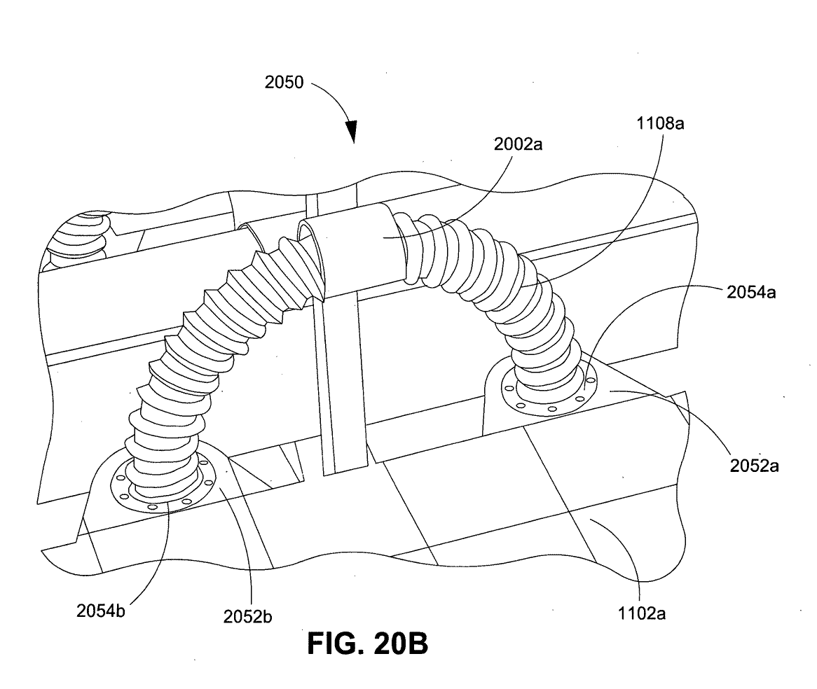

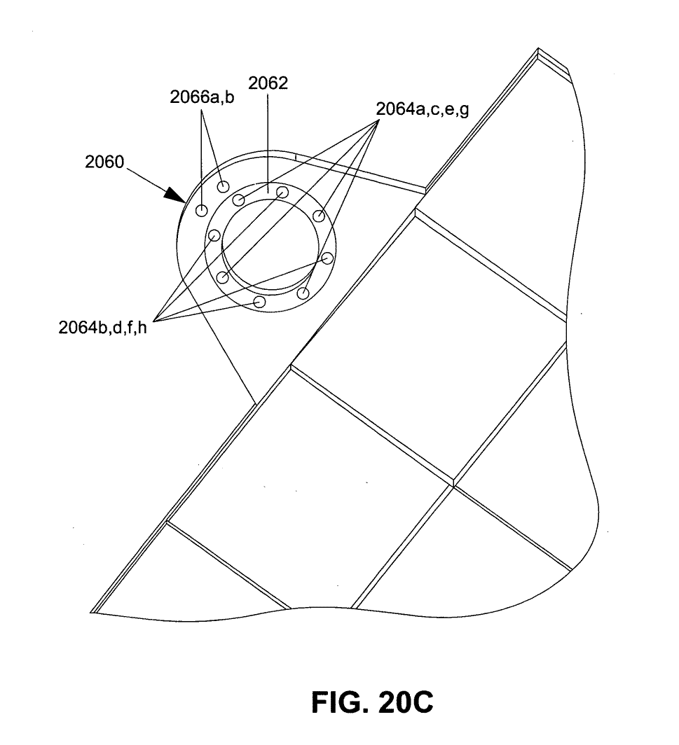

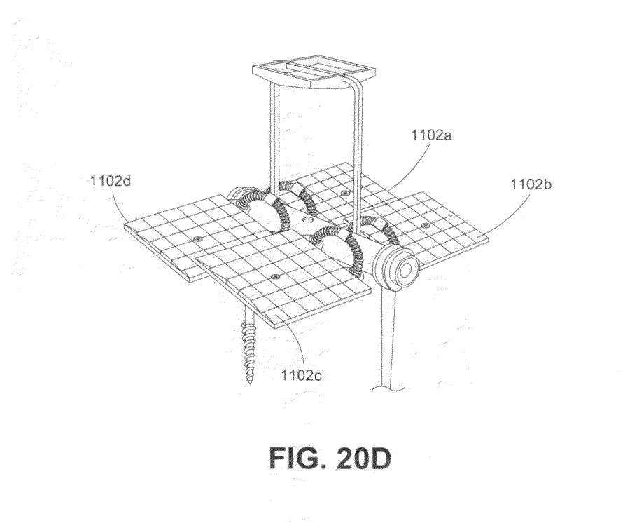

FIG. 20A shows an embodiment of a bracket of FIG. 11.

FIG. 20B shows an embodiment of a portion of the solar generator of FIG. 11.

FIG. 20C shows an embodiment of a portion of solar generator FIG. 11.

FIG. 20D shows an embodiment of solar generator having the solar panels of FIG. 11.

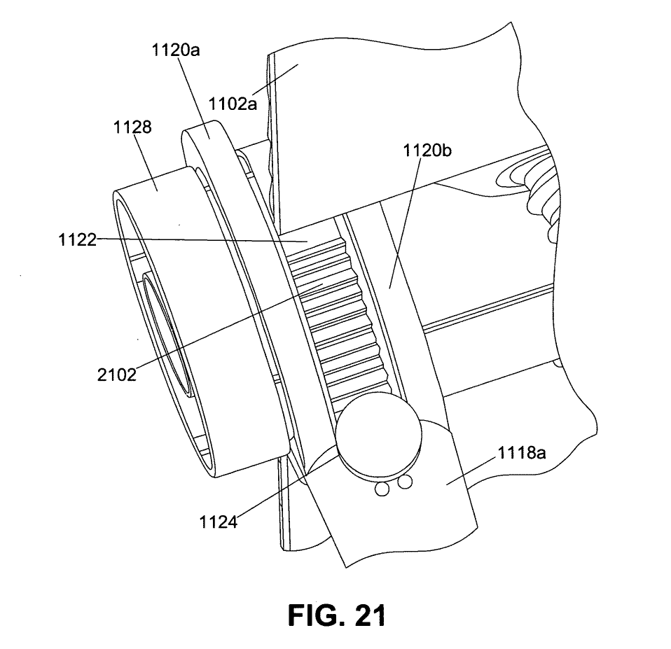

FIG. 21 shows an embodiment of a portion of solar generator of FIG. 11.

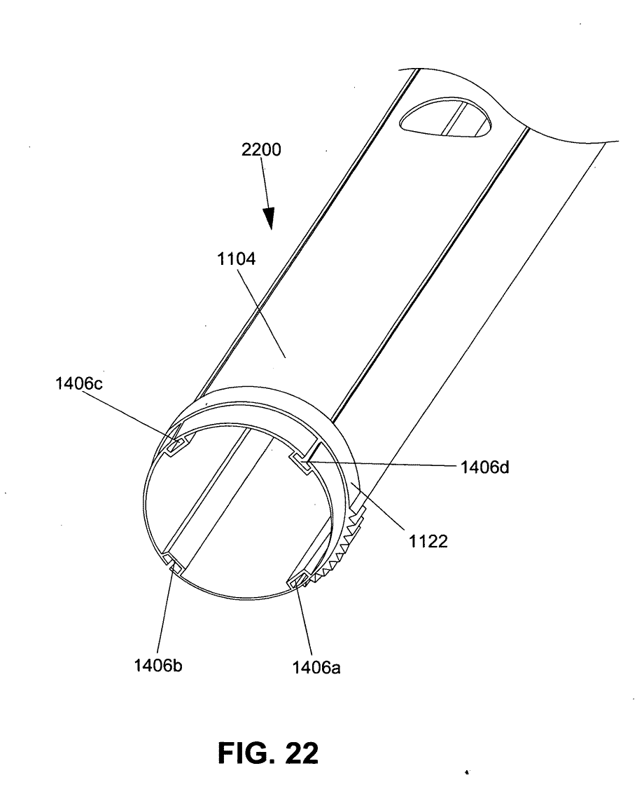

FIG. 22 shows an embodiment of a portion of the solar generator of FIG. 11.

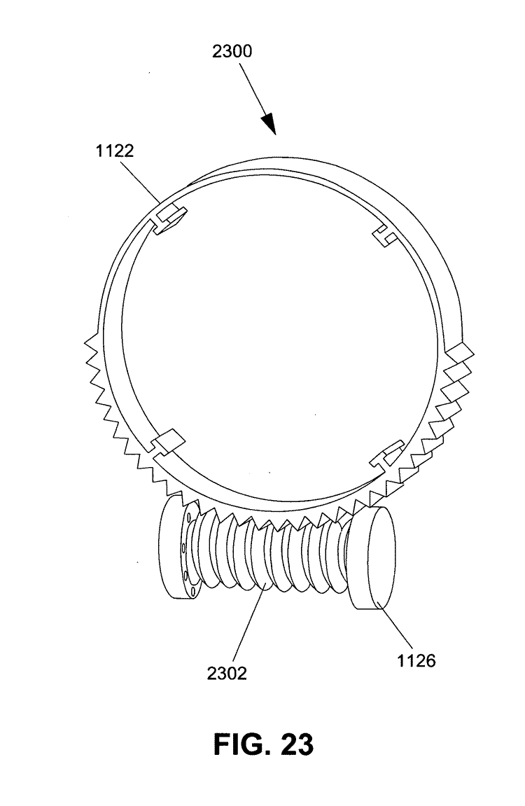

FIG. 23 shows an embodiment of a portion of the solar generator of FIG. 11.

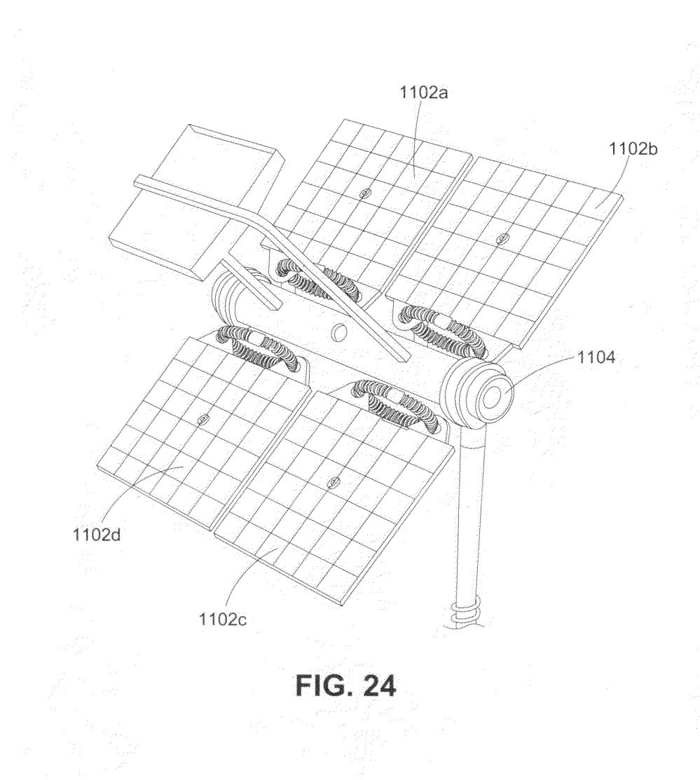

FIG. 24 shows an embodiment of solar generator.

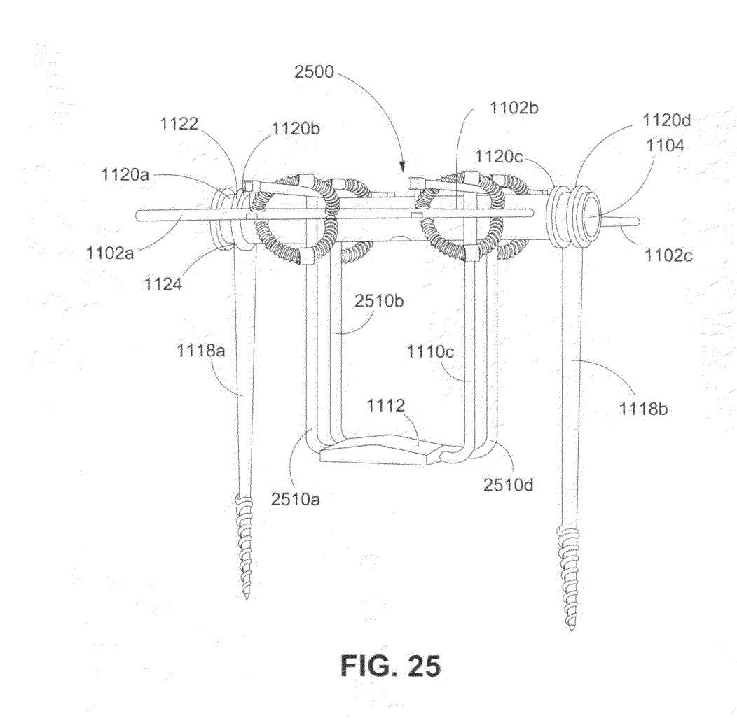

FIG. 25 shows an embodiment of a solar generator.

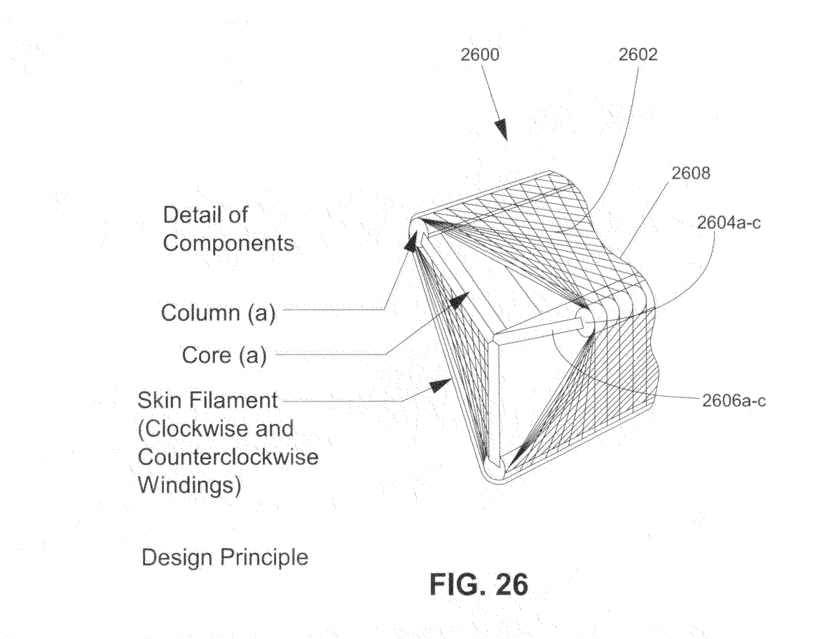

FIG. 26 shows an embodiment of a support, which may be the support of FIG. 12A.

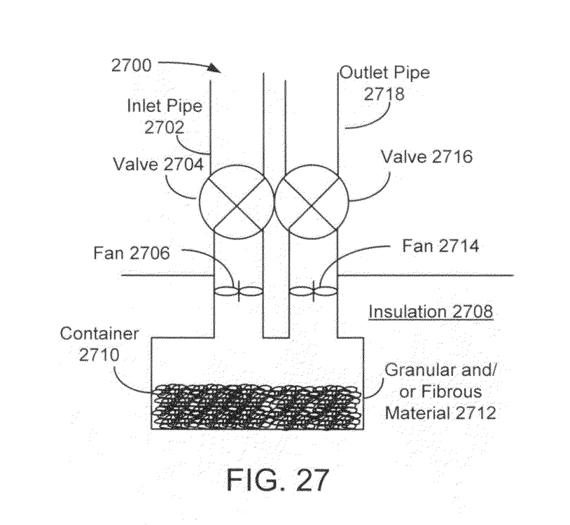

FIG. 27 shows a representation of an embodiment of a heat storage system.

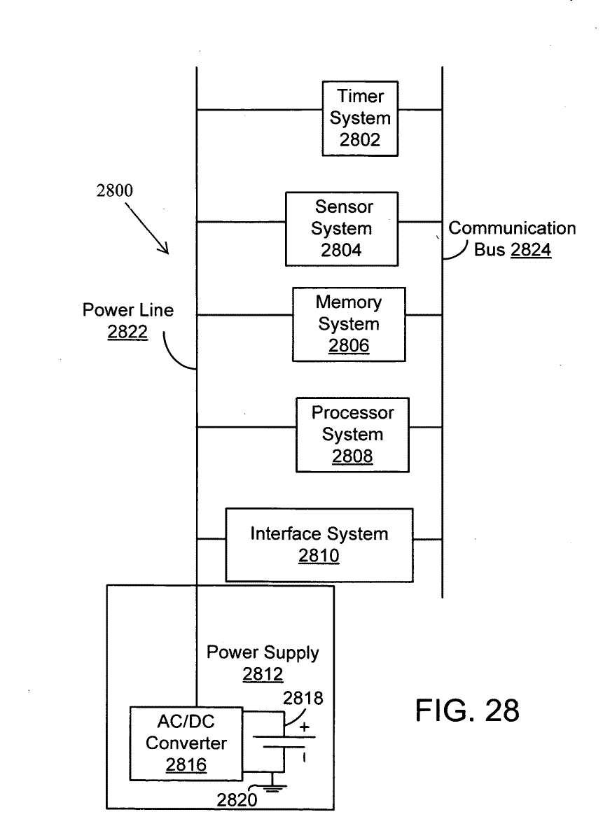

FIG. 28 shows a block diagram of the control circuit for controlling solar generator of FIG. 11.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Constructions Mosaic Mirror Panels

FIG. 1 shows a panel 100 including mirrors 102aa-ff on a support plate 104. In other embodiments panel 100 may not have all of the elements or features listed and/or may have other elements or features instead of or in addition to those listed.

A collection of several panels 100 be arranged to reflect light to one or more target regions. In an embodiment, panel 100 may be a square. In another embodiment, panel 100 may be rectangular, triangular, another polygon, circular, ovular, or another shape. Each panel 100 may have several mirrors, and each mirror may be tilted a slightly different amount in order to direct sunlight to the exact location or set of locations desired. The panel of mirrors has a mosaic appearance. In other embodiments, the panels may have other shapes, such as rectangles, hexagons, octagons, decagon, circles triangles, polygons, other two dimensional shapes and/or other shapes. By altering the number of mirrors and altering the tilt angles of the mirrors, different concentration ratios and distributions of light can be achieved.

Mirrors 102aa-ff may be an array of flat mirrors that are angled to reflect the light onto a target point or a target region. In an embodiment, each of mirrors 102aa-ff is flat and square. In another embodiment, mirrors 102aa-ff may be any shape and/or size. Mirrors 102aa-ff may be angled to obtain a desired light distribution over the target region where the light is collected. Angling mirrors 102aa-ff allows panel 100 to be a flat mirror surface. The flat surface is advantageous both for production and for transporting of the panels of the solar collectors. FIG. 1 panel 100 has an array of 6×6 panels in other embodiments there may be another number of mirrors (and/or as mentioned above arranged in a different shape). Although in the embodiment of Support plate 104 supports mirrors 102aa-ff.

FIG. 2 shows a reflective panel 200. Reflective panel 200 is similar to panel 100. However, panel 200 has a different number of mirrors. By mounting several mirrors on an aluminum frame and allowing the angle of each mirror to be adjusted to reflect light to its own receiver or to one or more common receivers, the mirrors can be used for a number of different applications. Any form of dual-axis tracking systems (or other tracking systems) may be employed with the panels of mirrors. A wide range of different receivers can be employed as part of the solar collector, such as PV cells, heat absorbers for air, heat absorbers for water, and/or heat absorbers for cooking. Different versions can be easily created for mounting on roofs, in towers or on the ground. Different version may have different sizes, which can range from a personal solar cooker to a large industrial drying system. For example, the mirrors may form solar cookers and/and or portable solar power generator, which may be mounted on a tower or other support.

In an embodiment tiles forming mirrors 02aa-ff having a mosaic or array of mirrors are mass manufactured in plastic, using one of several production methods. Alternatively, a polymer substrate may be produced using injection molding, and then the polymer substrate may be subjected to a vacuum deposition process to add a thin reflective layer such as aluminum or silver at different angels. Next, a protective layer of quartz or a similar material is deposited on at least the facets to form the mirrors on the substrate.

Another alternative is to insert a reflective polymer foil directly into a plastic injection mold, such as reflectech^{TN} made by 3M. The injection mold will fuse the mirror foil with the liquid polymer substrate as it is inserted into the mold. The process of inserting a foil into an injection mold may be referred to as Film Insert Molding (/FIM) or In-Mould Decoration (IMD).

As yet another alternative, a vacuum forming system is used to form a polymer plate with the mirror film attached. The polymer plate with the mirror is subjected to heating and then a vacuum that causes the metallic film to form over a negative mold.

Focal Points of Mosaic Arrays

FIG. 3A shows an example of a cross section of solar collector 300 having incident light rays 302a-e, reflective elements 304a-e, reflected light rays 306a-e, and target 308. In other embodiments cross section 300 may not have all of the elements or features listed and/or may have other elements or features instead of or in addition to those listed.

Incident light rays 302a-e are rays of light form the Sun, for example. Reflective elements 304a-e may be panels 100 and/or panels 200, for example. Each of reflective elements 304a-e may include an array of mirrors. Alternatively, each of reflective elements 304a-e may be a different facet of the same mirror panel. Reflected light rays 306a-e are the light rays reflected from reflective elements 304a-e. Target 308 is a target at which light rays 306a-e have been directed by reflective elements 304a-e.

FIG. 3B shows an example of a cross section of solar collector 350 having incident light rays 352a-e, reflective elements 354a-e, reflected light rays 356a-e, target 358, and target 360. In other embodiments cross section 350 may not have all of the elements or features listed and/or may have other elements or features instead of or in addition to those listed.

Incident light rays 352a-e are rays of light form the Sun, for example, similar to light rays 302a-e. Reflective elements 354a-e (similar to reflective elements 304a-e) may be panels 100 and/or panels 200, for example, and each of reflective elements 354a-e may include an array of mirrors or facets of the same mirror panel. Similar to reflected rays 306a-e, reflected light rays 356a-e are the light rays reflected from reflective elements 304a-e. However, in contrast to FIG. 3A, in FIG. 3B, there are two targets, targets 308 and 310, at which light rays 356a-e have been directed by reflective elements 354a-e. Similarly, by adjusting the angle of the panels and/or the mirrors of the panel instead of directing the light to just two targets, the light may be adjusted to a target region.

Panels of mirrors may be arranged in troughs, dishes and towers. Troughs concentrate the sun into a line, where fluids are heated and run a steam turbine. Dishes and towers concentrate the sun into a point, which has a higher temperature potential in return for a more complex tracking system. Trough mirrors are easier to manufacture than dish mirrors (one-dimensional versus two-dimensional), while tower mirrors can be flat.

Strictly speaking a flat facet or mirror has an infinite focal length. However, two definitions of focal point and focal length that are slightly different from the standard definition of a focal point and focal length are useful and may be used in this specification. In this specification, to redefine the terms focal length and focal point, consider a ray of light that is incident in a direction that is parallel to the normal of panel of facets at the center of the facet. The distance (that is the shortest distance from the plane of the midpoints of the facets) at which that ray of light reaches a location above a desired spot on the panel will be considered the focal length of that facet according to the first definition and the spot in space where the midpoint is above the desired spot on the panel is the focal point in the first definition. Regarding the second definition, if there are multiple facets that are angled to reflect their midpoint light rays to the same point, the point where the midpoint light rays meet will be referred to as a focal point and the shortest distance from the plane of the midpoints of the facets to the point where the midpoint rays meet is the focal length of that group of facets. In embodiments that never have just one facet angled to reflect light at a particular location (e.g., for heating), the two definitions are the define the same focal length and focal point, but the first definition allows one to associate a focal length with a single facet.

Orientation of Facets of Mosaic Panels

FIG. 4 shows a representation of an embodiment of a square panel 400, having mirrors 402aa-ff and cut line 404. In other embodiments square panel 400 may not have all of the elements or features listed and/or may have other elements or features instead of or in addition to those listed.

Square panel 400 is an embodiment of panels 100 and 200. Square panel 400 has 6 square mirrors (also called facets) on each side, and each side of the square panel 400 is 55 cm. In another embodiment, the panel 400 has 22×22 facets, and each facet is 2.5 mm×2.5 mm, which creates approximately a 500 fold concentration of light for each panels focused on the same spot. In another embodiment there may be another number of facets and/or a different size and/or shape panel. Any of the sizes and shapes of the panel and facets may be used in any embodiment of the solar collectors and solar generators described in this specification. Square panel 400 is an embodiment in which a polyhedral mirror is formed by a mosaic-like array of small flat mirrors. Each mirror is tilted in such a way that it reflects incident light towards the focal point.

Each of mirrors 402aa-ff is allotted a region of 55/6 cm˜9.17 cm. In an embodiment, each of mirrors 402aa-ff is a square having a length and width of 9.17 cm. Cut line 404 is not a physical structure, but just indicates the line along which the cross section of FIG. 5 was taken. Cut line 554 is located along the centers of one row of mirrors, e.g., along the center of mirrors 402ca, 402cb, 402cc, 402cd, 402ce, and 402af.

FIG. 5 shows a representation of an embodiment of a cross section 550 of the square panel 400 of FIG. 4. Cross section 550 includes mirrored surfaces 552, surfaces 554, midpoints 556, midpoint surface 557, angles 558, and pitch 560. In other embodiments cross section 550 may not have all of the elements or features listed and/or may have other elements or features instead of or in addition to those listed.

Cross section 550 is along the dotted cut line 404 of FIG. 4. Mirrored surfaces 552 may include a reflective layer, which may be white paint, a reflective polymer, and/or a specularly reflective material such as chrome or aluminum, for example, which reflect light towards a target region. Surfaces 554 do not need to be reflective, but can be reflective. By making surfaces 554 reflective some light reflected from surfaces 554 may be reflected onto surfaces 552, and some of the light from surfaces 554 reflected to surfaces 552 may be reflected to the target region. Midpoints 556 may be located in the centers of the mirrored surfaces 554. The collection of all midpoints 556 for the entire array of mirrors 402aa-ff (FIG. 4) may form a plane that may be parallel to the back surface of square panel 400 (FIG. 4). Midpoint surface 557 is the plane formed by midpoints 556. Angle 558 is the angle between surfaces 554 and the normal to midpoint surface 557. In an embodiment, angle 558 is 5 degrees. Pitch 560 is the length allotted to each facet, which is the distance between the intersection of surface 554 and a line joining the midpoints of a column or row of mirrors 402aa-ff (FIG. 4). In an embodiment, pitch 560 is 9.17 cm (or 55 cm/6) for the panel on which mirrored surfaces 552 are located.

Square panel 400 is a size has been determined by the inventor to be a practical size for injection-molded components, such that the cost of molds is relatively low, the stiffness of the mosaic mirrors is rigid enough so as not bend or deform during normal use. The resulting focal length is short enough to allow the panel to be incorporated in a unit that is small enough such that all components can be carried and handled easily by a single person. Constructing square panel 400 and/or the solar collector system including square panels 400 in a manner that one person can handle, construct, and use differs significantly from current system in which trucks and cranes must be used for installation, which apparently has not heretofore been recognized to be a problem in the prior art.

In one embodiment, a polyhedral mirror array, such as square panel 400, in configured to have one focal point or focal region. In another embodiment, the polyhedral array is arranged to have multifocal points and/or multiple focal regions. In another embodiment, each of a group of mirror facets in a set of groups of facets is directed to a different focal point within a particular region to form a focal region, which may also be referred to as a focal zone. Each group of facets may include one, two, three, or four facets. In an embodiment, two or all facets that are the same distance from the center of the panel are directed to the same focal location. The shape of focal zone and intensity distribution inside the focal zone can be adjusted according to the need at hand, by changing how close the focal points are to one another.

Mosaic mirror panels may be tilted around a center point. In other words, an embodiment, each of the mirrors of the array may be tilted around a central point. The individual mirrors may be tilted about 5° with respect to a plane parallel tot the panel. Surfaces between of the individual mirrors may be tilted 5° with respect to the normal to the plane parallel to the panel in order to facilitate injection molding. In one embodiment, each array of mirrors is 55 cm wide and 55 cm long, and there are 36 mirrors (or facets) in an array, with 6 mirrors (or facets) on each side of the array, and the angle of each facet is tilted an additional 5 degrees about the x axis for each 55 cm in the y component of the distance from the center the square and is tilted an additional 5 degrees about the y axis for each 55 cm in the x component from the center of the square.

In an embodiment in which the facets of the mirror have one focal point that is at a focal length off, a facet whose center is a distance d from the center of the panel may be oriented at an angle

θ=(π/2−α)/2, where α=tan⁻¹(f/d).

If there are an even number of rows and an even number of mirrors along the length then d is given by the equation

d=sqrt(X²+Y²)l=sqrt((n+1/2)²+(m+1/2)²)l,

where l is the pitch of the array of mirrors, which the size of the square allotted to each facet, m is an integer that is equal to the number of whole facets from the center of the panel to the center of the mirror along one axis and n is an integer that is equal to the number of whole facets from the center of the panel to the center of the mirror along an axis perpendicular to the first. If there are an odd number of panels along the first axis then X=n+1 and “(n+1/2)” in the formula for d is replaced by (n+1), and if odd number of panels along the second axis then Y=m+1 and “(m+1/2)” is replaced by (m+1) in the formula for d. The angle θ is measured along a line joining the center of the facet and the center of the panel. The facet is rotated from being flat by the angle θ about and axis perpendicular from a line connecting the center of the panel and the center of the facet.

FIG. 6 illustrates an embodiment of a panel of 6×6 facets. FIG. 6 illustrates that the distance d from the center of the panel to the center of a facet is given by

d=sqrt(x²+Y²)l=sqrt((n+1/2)²+(m+1/2)²)l.

FIG. 7 illustrates an embodiment in which the focal length of the panel is f. From FIG. 7, one can see that θ=(π/2−α)/2, where α=tan⁻¹(f/d). In order to create a focal region having a distribution of focal points each facet i,j, is set to the angle

θ_{i,j}=(π/2−α_{i,j})/2, where α_{i,j}=tan⁻¹(f_{i,j}/d_{i,j}).

The mosaic reflective panels may be made from an all polymer super-reflective film from 3M attached to a plastic substrate, which allows mass manufacturing of mirror tiles using Film Insert Molding (FIM). The facets of the mosaic reflectors may be arranged in a dish (2D concentration) configuration to achieve higher concentration ratios than 1D troughs. To avoid the need for stretching the reflective film, which otherwise would be necessary to make dish shapes, the mosaic panels are constructed from an array of flat facets. In an embodiment, the panels are made from flat tiles (60×60×2 cm) that can be designed to concentrate from 10 to 1000 times. The all polymer mosaic panels with flat facets may 94% reflectivity, and has a more even beam distribution than traditional dish or Fresnel systems, which allows both higher energy production and longer life.

Solar Cooker

FIG. 8 shows an example of an embodiment of a solar cooker 800 having panels 802a-h, containers 804, basket 806, support bars 808 and 810, lines 812, and support structure 814. In other embodiments solar cooker 800 may not have all of the elements or features listed and/or may have other elements or features instead of or in addition to those listed.

Solar cooker 800 may be portable and may include a polyhedral array that directs sunlight onto surfaces of two containers that absorb light/heat, which thereby causes the sunlight to heat the contents of containers. The fluids referred to in this specification may be a gas or liquid, such as air, water, or another fluid. Panels 802a-h may be embodiments of panels 100 and/or 200. Each of panels 802a-h may be angled at a different angle to direct sunlight at one or more containers, solar cells, and/or other forms of converting sunlight and/or heat into another form of energy.

Containers 804 may absorb heat, which is transferred to the contents of containers 804. In an embodiment, containers 804 may be ordinary cooking containers, such as pots and/or pans. Alternatively or additionally, containers 804 may be painted a dark color, such as black to better absorb heat. Containers 804 may be made from heat conductive material, such as metal, such as steal, iron, copper, or aluminum, so that the sunlight shining of the surfaces of containers 804 heats the walls of containers 804, which in turn transfer the heat to the fluid within containers 804. Containers 804 may include removable covers. In an embodiment, surface that are intended to be exposed to the sunlight are made from either a transparent material and/or a heat conductive material and surfaces that are not intended to be exposed to sunlight are made from an opaque, insulating material, so that heat is not lost through those surfaces. Although FIG. 8 shows two fluid tanks as containers 804, there may be one, two, three, or any number of fluid tanks. In another embodiment, another type of solar cell may be located next to, replace, and/or may be included within containers 804.

Basket 806 holds containers 804 in place. Basket 806 may be made from a lattice of bars or another structure having large openings via which sunlight may pass to heat containers 804. In an embodiment, basket 804 is made from a transparent and/or heat conductive material that transfers light and/or heat emanating form panels 802a-h to containers 804. Basket 806 is optional.

Support bars 808 and 810 support basket 806. Support bars 808 and 810 may be attached to basket 806. In an embodiment without basket 806, support bars 808 and 810 may be connected directly to one or more containers 804.

Lines 812 may be resistive heating, electrical cables for supplementing the heat of the sunlight (e.g., when sunlight is not available). Lines 812 may be gas lines for bringing gas for a flame and/or hot water lines bring hot water that supplement the heat from the sunlight.

Frame 814 and support bars 808 and 810 hold panels 802a-h and support bars 808 and 810 in a fixed special relationship with respect to one another. In an embodiment, frame 814 may attach to a tower or another structure.

Portable Trough Solar Generator

FIG. 9 shows an example of an embodiment of a solar power generator 900 having panels 902a-h, receiver 904, support bars 908 and 910, lines 912, and frame 914. In other embodiments solar power generator 900 may not have all of the elements or features listed and/or may have other elements or features instead of or in addition to those listed.

Solar power generator 900 may be portable and may include a polyhedral array that directs sunlight to a receiver, which thereby causes the sunlight to heat a fluid flowing through the receiver. The fluids referred to in this specification may be a gas or liquid, such as air, water, or another fluid. Panels 902a-h may be embodiments of panels 100, 200, 300, 350, 400, and/or 802a-h, which are discussed above.

Receiver 904 may absorb heat, which is transferred to fluids within receiver 904. In an embodiment, receiver 904 may include a fluid reservoir, which may include a container and/or a pipe. The pipe may be is folded so as to increase the length of pipe that is within the target region of panels 902a-h. Alternatively or additionally, receiver 904 may be painted a dark color, such as black to better absorb heat. Receiver 904 may be made from heat conductive material and/or a transparent material, so as to facilitate transferring heat and/or light reflected from panels 902a-h to a fluid within receiver 904. The pipes of the receiver may be made from a metal, such as steal, iron, copper, or aluminum, so that the sunlight heats the walls of receiver 904, which in turn transfer the heat to the fluid within receiver 904. In an embodiment, surfaces of receiver 904 that are intended to be exposed to the sunlight are made from either a transparent material and/or a heat conductive material and surfaces that are not intended to be exposed to sunlight are made from an opaque, insulating material, so that heat is not lost through those surfaces. Receiver 904 may include heat conductive plates attached to the fluid reservoir to collect heat from a larger area than the area of the fluid reservoir and conduct the heat to the fluid reservoir.

Support bars 908 and 910 support receiver 904. Support bars 908 and 910 may be attached to receiver 904. In an embodiment, support bar 908 may be attached to a base upon which solar power generator 908 may stand while in use. Alternatively, support bar 908 may include a pointy end that may be hammered into the ground, to hold solar power generator 900 standing while in use (and/or include a ground screw for anchoring solar power generator 900 to the ground).

Lines 912 may be resistive heating, electrical cables for supplementing the heat of the sunlight (e.g., when sunlight is not available). Lines 912 may be gas lines for bringing gas for a flame and/or hot water lines bring hot water that supplement the heat from the sunlight and hear receiver 904.

Frame 914 and support bars 908 and 910 support panels 902a-h holding panels 902a-h and support bars 908 and 910 in a fixed special relationship with respect to one another. In an embodiment, frame 914 may attach to a tower or another structure. Frame 914 may be similar or the same as frame 814.

Tower Solar Generator

FIG. 10 shows an example of an embodiment of a tower solar generator 1000 having array of panels 1002a and b, receivers 1004a and b, support bars 1008a and b, frames 1014a and b, tower 1016, vertical bars 1017a-d, struts 1018, and base 1022. In other embodiments tower solar generator 1000 may not have all of the elements or features listed and/or may have other elements or features instead of or in addition to those listed.

Power solar generator 1000 includes multiple solar panel arrays for generating power from sunlight. Each array of panels 1002a and b is similar to, and may be the same as, the array formed by panels 802a-h or the array formed by panels of 902a-h, which were discussed above. Each of receivers 1004a and b may be the same as receiver 904, which were discussed above. Support bars 1008a and b support receivers 1004a and b, respectively. Frames 1014a and b attach support bars 1008a and b to array of panels 1002a and b, hold array of panels 1002a and b together, and attach array of panels 1002a and b to the tower, respectively Tower 1016 supports array of panels 1002a and b, via frames 1014a and b, respectively. Tower 1016 may include three vertical bars 1017, which are held together by struts 1018. Although struts 1018 are oriented diagonally, tower 1016 may also include horizontal struts and/or struts at other angles, in addition to or instead of struts 1018. In an alternative embodiment there may be four vertical bars, instead of three. Although FIG. 10 shows only two arrays of panels, tower 1016 may support any number of arrays of panels. Optional base 1022 supports vertical bars 1017. Base 1022 may be square, rectangular, circular, oval, triangular or any other shape.

Butterfly Solar Generator

FIG. 11 shows an embodiment of a top of solar generator 1100 having solar panels 1102a-d, outer cylinder 1104, lens 1105, inner cylinder 1106, circular worm gear 1108a-d, supports 1110a-d secondary mirrors 1112, solar cell 1114, day sensor 1116, ground screws 1118a and b having rings 1120a-d, and collar gear 1122, knob 1124, threads 1126a and b, and outer collar 1128. In other embodiments top of solar generator 1100 may not have all of the elements or features listed and/or may have other elements or features instead of or in addition to those listed.

Solar generator 1100 is an inexpensive solar powered generator, which may be easily assembled by a novice (given some instructions). Each of solar panels 1102a-d may be the same as solar panels 100, 200, 300, 400, or 550. Solar concentration creates high temperatures at the focal point, so if solar cells are used they require the cells to be either actively or passively cooled. Most existing solar concentrating systems are solely designed to utilize the electricity output and simply dissipate the heat. However, this heat can be applied to a number of different important energy-consuming applications, such as water heating, pasteurization, desalination, drying of food, air conditioning and freezing. As an additional significant benefit, such heat applications provide higher carbon savings than the electricity generation portion. In the disclosed systems, carbon savings from both heat and electricity are achieved at the same time. Solar cells have an optimal operational temperature of 60-80 C, which is the resulting temperature of the waste heat of the disclosed systems. If a heat-driven engine is used, the waste heat can be up to 200 C, which enables a wider range of applications.

Outer cylinder 1104 houses a receiver that receives heat. Outer cylinder has a hole on top through which light is directed to the receiver. Solar panels 1102a-d are rotatably attached to outer cylinder 1104. Lens 1105 is located in the hole in outer cylinder 1104, and focuses light onto a receiver within outer cylinder 1104. In an embodiment, lens 1105 is transparent plug rather than a lens and may be made form plastic or borosilicate glass, for example. Inner cylinder 1106 is mounted within outer cylinder 1104, within which pipes for carrying a fluid. Circular worm gears 1108a-d are attached to panels 1102a-d, respectively. Magnetic motors rotate are placed in panels 1102a-d that rotate panels on worm gears 1108a-d about axes that are perpendicular to the axis at the center of outer cylinder 1104 to track the Sun as the Sun moves through the sky during the day and/or as a result of changes in the orientation of the Earth's axis with the changing seasons. Supports 1110a-d support a secondary mirror and are attached to outer cylinder 1106.

Secondary mirrors 1112 reflect light from panels 1102a-d into the hole at the top of outer cylinder 1106 to heat the receiver. Secondary mirrors 1112 are supported by supports 1110a-d. Solar cell 1114 may power a motor and circuit for that changes the orientation of panels 1102a-d to track the Sun. Thus, in addition to the mosaic primary collector (panels 1102a-d), there is also secondary mirrors 1112 on top which both redirects the beams downwards and allows a folded light path, halving the focal distance. In an embodiment, secondary mirrors 1112 are fixed and do not move. In another embodiment secondary mirror 1112 includes four a mosaic panel with facets. In another embodiment secondary mirror 1112 includes four mosaic panel with facets.

On top of the secondary mirror 1112 may be a circuit board in addition to, or instead of, solar cell 1114, which controls and/or powers the tracking. In an embodiment, the controller circuit board is sandwiched under a solar cell 1114 on top of the secondary mirror, and contains an embedded CPU, which may control the 8 mosaic motors (two for each panel) and the daily tracking and/or may control a motor for rotating outer cylinder 1106.

Day sensor 1116 senses whether it is day time. If day sensor 1116 senses that it is day time, the circuit that controls the tracking of the Sun is activated. Ground screws 1118a and b screw into the ground and support outer cylinder 1106. Ground screws 1118a and b serve as legs supporting the rest of solar generator 1100. Only two ground screws are necessary to support the rest of solar generator 1100, because ground screws 1118a and b anchor into the ground. Rings 1120a-d hold outer cylinder holding outer cylinder on ground screws 1118a and b. Although rings 1120a-d are shown as one solid piece ring that does not open, rings 1120a-d may have hinges and may open and snap close around outer cylinder 1104 (and/or may open and close in another manner and/or be partially open).

Thus, instead of using traditional concrete foundations, ground screw 1118a and b are used, which assures quick, inexpensive insertion without any environmental impact. In an embodiment, ground screws 1118a and b are made from plastic and may include a motor integrated within ground screws 1118a and b. In an embodiment, ground screws 1118a and b are replaced with poles in water ballast foundations.

In an embodiment, ground screws 1118a and b may be formed by roto-molding. In an embodiment, a heated mold causes the material within to melt and form a puddle at the bottom of the mold cavity. The mold is then slowly rotated (e.g., around two perpendicular axes) causing the melted material to flow into to the mold and stick to the walls of the mold. In order to maintain even thickness throughout the ground screws 1118a and b, the mold may continue to rotate during the cooling phase.

Collar gear 1122 may be used to rotate outer cylinder 1104 about the axis of outer cylinder 1104, which rotates the rest of solar generator 1100 about the same axis. Collar gear 1122 may be used to point solar generator 1100 towards the Sun. In an embodiment, collar gear 1122 is rotated manually by rotating knob 1124. In another embodiment, a motor turns collar gear 1222, and optionally the motor may be controlled by a circuit that tracks the Sun.

Threads 1126a and b may be used to drill ground screws 1118a and b into the ground by turning ground screws 1118a and b while pushing ground screws 1118a and b into the ground. Outer collar 1128 may be used to connect two outer cylinders together.

Conventional solar panels are today manufactured using steel, glass and concrete. In contrast, solar generator 1100 may be constructed from low-carbon, low-cost, light-weight materials such as plastics to the largest extent. The solar generator 1100 maybe manufactured with an extremely small carbon footprint in recycled plastics using solar generator 1100 to power the plastics factory. Designing using plastics requires a completely different structure compared to the current systems, so solar generator 1100 has a unique appearance, has a low center of gravity, low profile (less wind pressures to overcome), and may be assembled without tools. For heat based application, solar generator 1100 may be located in proximity to the point of use to facilitate heat distribution.

In an embodiment, solar panel 1100 there is no welding or bending of the aluminum parts. The components are packaged in containers for distribution directly to the final site. In an embodiment, solar generator 1100 may be assembled without tools by unskilled labor. In an embodiment, solar generator 1100 has an areal density of 15 kg/m² including the foundation (which does not have concrete).

Bottom of Butterfly Solar Generator

FIG. 12A shows an embodiment of a bottom of solar generator 1100 having solar panels 1102a-d, outer cylinder 1104, inner cylinder 1106, circular worm gear 1108a-d, supports 1110a-d secondary mirrors 1112, solar cell 1114, day sensor 1116, ground screws 1118a and b having rings 1120a-d, and collar gear 1122, knob 1124, 1126a and b, secondary mirror panels 1202a-d, optional support bars 1204a and b, and optional bar mounts 1206a-d. In other embodiments, bottom of solar generator 1100 may not have all of the elements or features listed and/or may have other elements or features instead of or in addition to those listed.

Panels 1102a-d, outer cylinder 1104, inner cylinder 1106, lens 1105, circular worm gear 1108a-d, supports 1110a-d secondary mirrors 1112, solar cell 1114, day sensor 1116, ground screws 1118a and b having rings 1120a-d, collar gear 1122, knob 1124, and threads 1126a and b were discussed in conjunction with FIG. 11. Secondary mirrors 1202a-d reflect light from panels 1102a-d into outer cylinder 1104. In the embodiment of FIG. 12A, mirrors 1202a-d are angled outwards, so that mirror 1202a reflects light form panel 1102a, mirror 1202b reflects light form panel 1102b, mirror 1202c reflects light form panel 1102c, and mirror 1202d reflects light form panel 1102d. However, in another embodiment, mirrors 1202a-d are angled inwards, and panels 1102a-d are angled so that mirror 1202a reflects light form panel 1102c, mirror 1202b reflects light form panel 1102d, mirror 1202c reflects light form panel 1102a, and mirror 1202d reflects light form panel 1102b.

Support bars 1204a and b support panels 1102a-d keeping panels 1102a-d from collapsing and/or to keep panels 1102a-d rigid. Support mounts 1206a-d mount support bars 1204a and b to panels 1102a-d. Each of support bars 1204a and b has a support mount at each end, and each support mount is attached to the center of one of panels 1102a-d. Although in FIG. 12A support bars 1204a and b are drawn as passing through circular worm gears 1108a and b, in an embodiment support bar 1204a and b are located below circular worm gears 1108a and b. In another embodiment, solar generator 1100 does not have support bars 1204a and b and/or has another set of support bars.

FIG. 12B shows an embodiment of solar collector 1250, which may include panels 1102a-d, secondary mirrors 1252a-d, and supports 1254a-d. In other embodiments, bottom of solar generator 1250 may not have all of the elements or features listed and/or may have other elements or features instead of or in addition to those listed.

Solar generator 1250 is similar to solar generator 1100. However, solar generator 1250 has four separate secondary mirror units in contrast to secondary mirrors 1202a-d, which are located in one unit. Secondary mirrors 1252a-d may each be a single flat mirror or may be mosaic mirrors with facets angled to further concentrate the beam of light. Also, supports 1254a-d are connected to panels 1102a-d, respectively, in contrast to support bars 1110a-d, which are held fixed with outer cylinder 1104. By connecting supports 1254a-d are connected to panels 1102a-d, secondary mirrors 1252a-d rotate with panels 1102a-d, respectively.

Support Mount

FIG. 13A is an embodiment of support mount 1300, which may include sleeve 1302, post 1304, and flanges 1306 and 1308. In other embodiments support mount 1300 may not have all of the elements or features listed and/or may have other elements or features instead of or in addition to those listed.

Support mount is an embodiment of any of support mounts 1208a-d. Sleeve 1302 engages one end of a support bar, and may have the same shape as support bars 1204a and b so that support bars 1208a-b can each slide into sleeve 1302. Post 1304 has sleeve 1302 at one end and a connector that engages the center of one of panels 1102a-d at another end. Flanges 1306 and 1308 sandwich one of panels 1102a-d, with flange 1308 on top of the panel and flange 1306 underneath the panel, thereby holding support mount 1300 in place on the panel. Post 1304 and/or flanges 1306 and 1308 may be made from a flexible material, such as rubber so that as panels 1102a-d rotate post 1304 and/or flanges 1306 and 1308 bend allowing panels 1102a-d to bend despite support bars being stationary.

FIG. 13B is an alternative embodiment of support mount 1300, which may include sleeve 1302, post 1304, flanges 1306 and 1308, ball 1352, and socket 1354. In other embodiments support mount 1300 may not have all of the elements or features listed and/or may have other elements or features instead of or in addition to those listed.

Sleeve 1302, post 1304, and flanges 1306 and 1308 were discussed in conjunction with FIG. 12A. Ball 1352 rotates within socket 1354, which allows plates 1102a-d to rotate with respect to support bars 1204a and b even though support bars 1204a and b were held stationary with respect to outer cylinder 1104.

Inner and Outer Cylinders

FIG. 14 shows an embodiment of a portion 1400 of solar generator 1100, which includes outer cylinder 1104, lens 1105, inner cylinder 1106, hole 1402, pipe 1404, channels 1406a-d, and channel 1406b includes flanges 1408a and b and slit 1410. In other embodiments portion 1400 may not have all of the elements or features listed and/or may have other elements or features instead of or in addition to those listed.

Outer cylinder 1104, lens 1105, and inner cylinder 1106 were discussed in conjunction with FIG. 11. Hole 1502 holds lens 1105, and allows light to pass into outer cylinder 1104. Pipe 1404 carries a fluid that is heated by the light directed through lens 1105. Channels 1406a-d ′ interlock with protrusion on other components that have a complementary shape to channels 1406a-d to allow the other components to be attached to outer cylinder 1104. Flanges 1408a and b cover channel 1406b and form slit 1410. Each of channels 1406a-d has flanges and slits similar to flanges 1408a and b and slit 1410. In another embodiment, channels 1406a-d and the shape of the protrusions that interlock with channels 1406a-d may have another shape. Although FIG. 14 shows 4 channels, in an embodiment, there may be another number of channels (e.g., one, two, three, five, six, or more channels).

FIG. 15 shows inner cylinder 1106 with inner collar 1502. In other embodiments cylinder 1106 may not have all of the elements or features listed and/or may have other elements or features instead of or in addition to those listed.

Inner cylinder 1106 is described in conjunction with FIG. 11. Inner collar 1502 fits over and slides onto cylinder 1106. Inner collar 1502 may be used to hold two inner cylinders together.

Inner and Outer Collars

FIG. 16 shows an embodiment of inner collar 1502 and outer collar 1128, which includes T-shaped protrusions 1602a-d. T-shaped protrusion 1602c includes stem 1604 and cross bar 1608. In other embodiments, inner collar 1502 and outer collar 1128 may not have all of the elements or features listed and/or may have other elements or features instead of or in addition to those listed.

Inner collar 1502 is discussed in conjunction with FIG. 15, and outer collar was discussed in conjunction with FIG. 11. T-shaped protrusion 1602a-d interlock with, and have shape that is complementary to, channels 1406a-d (FIG. 14). Stem 1604 fits into slit 1410. Cross bar 1608 fits into one of channels 1406a-d and is held in place by flanges 1408a and b (FIG. 14). Each of T-shaped protrusions 1602a-d has a step and cross surface. T-shaped protrusions 1602a-d may be used to secure outer collar 1128 to outer cylinder 1104. If channels 1406a-d have a different shape than illustrated in FIG. 14, T-shaped protrusions 1602a-d are replaced with another shape that is complementary to channels 1406a-d.

Linked Butterfly Solar Generators

FIG. 17 shows an embodiment of linked solar generators 1700, which includes solar generators 1702, 1704, 1706, and 1708. In other embodiments linked solar generator 1700 may not have all of the elements or features listed and/or may have other elements or features instead of or in addition to those listed.

Linked solar generators 1700 includes several solar generators linked together for generating more power. Each of solar generators 1702-1704 is modular and may be an embodiment of solar generator 1100 of FIG. 11. At each connection between two solar generators, only one ground screw is present, and the two solar generators that are linked share a ground screw at the junction where the two solar generators connect. At each connection, the two adjacent inner cylinders 1106 (FIG. 11) are held together by an inner collar (such as inner collar 1502), and the two adjacent outer cylinders are held together by an outer collar (such as outer collar 1128 shown in FIGS. 11 and 16).

The facets (which are mosaic mirror tiles) of the reflective panels may be mounted in a linear fashion to form a focal region that is similar to that of a trough or may be mounted to form a focal region that is similar to a bowl. Mounting the mosaic mirrors in a linear fashion, combines the structural integrity of a trough, based system with the higher efficiency of a dish system. The central spine of the each may contain the heat pipes and are designed to simply snap to each other, forming long rows in the north/south direction. The modular approach illustrated in FIG. 17, allows connecting enough modules to produce from 1 kW to several GW (depending on how may modules are connected together), and the modules can be mounted both on industrial roofs as well as on the ground.

Receiver

FIG. 18A shows an embodiment of receiver 1800, which includes pipe 1802 having straight sections 1804, 1806, and 1808 and bends 1810 and 1812. Receiver 1800 may also include plate 1814 having flanges 1816, 1818, 1820, 1822 1824, and 1826 and sloped section 1828. Solar concentration creates high temperatures at the focal point, so if solar cells are used they require the cells to be either actively or passively cooled. Most existing solar concentrating systems are solely designed to utilize the electricity output and simply dissipate the heat. However, this heat can be applied to a number of different important energy-consuming applications, such as water heating, pasteurization, desalination, drying of food, air conditioning and freezing. As an additional significant benefit, such heat applications provide higher carbon savings than the electricity generation portion. In the disclosed systems, carbon savings from both heat and electricity are achieved at the same time. Solar cells have an optimal operational temperature of 60-80 C, which is the resulting temperature of the waste heat of the disclosed systems. If a heat-driven engine is used, the waste heat can be up to 200 C, which enables a wider range of applications.

Receiver 1800 receives heat and/or light that was directed into outer cylinder 1104 and inner cylinder 1106, and the heat heats a fluid in the pipes of receiver 1800. Pipe 1802 carries the fluid in the receiver 1800. Pipe 1802 is bent in a region that is intended to be placed under the holes in outer cylinder 1104 and inner cylinder 1106. Straight portions 1804 and 1808 bring fluid to and from the bent portion where the fluid is heated. Straight portion 1806 carries the fluid from one bend to another. Bends 1810 and 1812 change the direction of the flow of the fluid so that the fluid is exposed to the incoming sunlight for a longer period of time. Specifically, bend 1810 carries fluid between straight portions 1804 and 1806 and bend 1812 carries fluid between straight portions 1806 and 1808. Although pipe 1802 is illustrated as having three bends, in other embodiments, pipe 1802 may have more bends. Alternatively, instead or in addition to bends, pipe 1802 may have a reservoir at the region where light is expected to shine that is heated by the light, thereby heating the air in the reservoir.

Plate 1814 collects sunlight on one surface that collects light, which heats plate 1814. The heat collected by plate 1814 is conducted to pipe 1802 and heats the fluid within pipe 1802. Plate 1814 functions in a manner similar to a heat sink. However, heat sinks are usually used to cool something and tend to conduct heat away form the item being cooled, whereas plate 1814 is kept at a relatively high temperature as are result of sunlight shining on plate 1814, and conducts heat towards pipe 1802. Flanges 1816 and 1818 are contoured to fit around straight portion 1804 and hold straight portion 1804 in place. Flanges 1816 and 1818 may also conduct heat towards straight portion 1804. Similarly, flanges 1820 and 1822 are contoured to fit around straight portion 1806, hold straight portion 1806 in place, and may also conduct heat towards straight portion 1806. Also, flanges 1824 and 1826 are contoured to fit around straight portion 1808, hold straight portion 1808 in place, and may also conduct heat towards straight portion 1808. Sloped section 1828 is a portion of plate 1814 that is sloped or beveled so that less of the heat collected by plate 1814 is dissipated into the air and more heat is conducted towards pipe 1802.

For heat applications, a simple fibrous receiver with black steel wool inside the central steel pipe absorbs the rays and turns the energy into heat. A borosilicate glass plug keeps the heat inside the pipe, and also serves as a tertiary optic to further concentrate the light. A fan sucks air or another fluid into the pipe and a thermostat adjusts the fan speed to achieve the desired air temperature.

FIG. 18B shows an embodiment of a portion 1850 of solar generator 1100, which includes outer cylinder 1104, inner cylinder 1106, hole 1402, plate 1812, and hole 1852. In other embodiments portion 1850 may not have all of the elements or features listed and/or may have other elements or features instead of or in addition to those listed.

Outer cylinder 1104, inner cylinder 1106, hole 1402, and plate 1812 were discussed above in conjunction with FIGS. 11, 14 and 18, respectively. Hole 1852 is a hole in inner cylinder 1106, via which light may shine onto plate 1812. Optionally, there may be a transparent plug or lens in hole 1852 in addition to or instead of lens 1105 or a transparent plug replacing lens 1105. Light from panels 1102a-d (FIG. 11) is directed through hole 1412, into hole 1852, and onto plate 1812, which heats plate 1812, and which in turn eventually heats the fluid in the receiver.

Circular Worm Gear Mounted on Outer Cylinder

FIG. 19 shows an embodiment of a portion 1900 of solar generator 1100 having outer cylinder 1104 having channels 1406a-d, circular worm gears 1902a and b, and brackets 1904a and b. In other embodiments portion 1900 may not have all of the elements or features listed and/or may have other elements or features instead of or in addition to those listed.

Outer cylinder 1104 was discussed in conjunction with FIG. 11. Channels 1406a-d were discussed in conjunction with FIG. 14. Worm gears 1902a and b is an embodiment of any of worm gears 1108a-d, which were discussed above in conjunction with FIG. 11. Brackets 1904a and b hold worm gears in place with respect to outer cylinder 1104 and attach to outer cylinder 1104, via channels 1406a and b. The circular worm gears allow for +/−85 degrees adjustment of panels 1102a-d.

Bracket

FIG. 20A shows an embodiment of bracket 2000, which may include sleeves 2002a and b, arms 2004a and b, central portion 2006, and T-shape protrusions 2008a and b. In other embodiments bracket 2000 may not have all of the elements or features listed and/or may have other elements or features instead of or in addition to those listed.

Bracket 2000 is an embodiment of brackets 1904a and b. Sleeves 2002a and b hug worm gears, arms 2004a and b attach sleeves 2002a and b to the rest of bracket 2000. Central portion 2006 hugs the outer cylinder and connects the arms 2004a and b. T-shaped protrusions 2008a and b connect bracket 2000 to the outer cylinder. In an embodiment, a motor may be attached to sleeves 2002a and b to rotate the circular worm gears and thereby rotate the orientation of the solar panel attached to the circular worm gear.

Panel Tabs

FIG. 20B shows an embodiment of a portion 2050 of solar generator 1100. Portion 2052 may include circular worm gear 1108a, bracket 1904a, sleeve 2002a, and portion of panel 1102a having tabs 2052a and b having rings 2054a and b. In other embodiments portion 2050 may not have all of the elements or features listed and/or may have other elements or features instead of or in addition to those listed.

Circular worm gear 1108a, bracket 1904a, and sleeve 2002a were discussed in conjunction with FIGS. 11, 19, and 20A. Portion of panel 1102a is a portion of the panel 1108a described in FIG. 11. Tabs 2052a and b are attached to and may be an integral part of panel 1102a. Tabs 2052a and b engage opposite portion of circular worm gear 1108a. In an embodiment, tabs 2052a and b include a motor (e.g., a magnetic motor) that engage circular worm gear 1108a and cause panel 1102a to rotate about circular worm gear 1108a.

A simple electromagnetic motor built in to panels 1102a-d, which moves an extremely slow speeds and lowers the cost significantly, which allows placing two motors integrated in every one of panels 1102a-d. In addition to catering for seasonal tracking and different latitudes it also corrects deviations in the concentrator structure (either in manufacturing or during use), allows light from panels 1102a-d to converge on a single spot and finally provides the fine control necessary for high concentration ratios.

FIG. 20C shows an embodiment of a portion 2060 of solar generator 1100. Portion 2060 may include ring 2062, first polarity magnets 2064a, c, e, and g, second polarity magnets 2064b, d, f, and h, and electromagnets 2066a and b. In other embodiments portion 2060 may not have all of the elements or features listed and/or may have other elements or features instead of or in addition to those listed.

As ring 2062 rotates, the tab of the panel moves along circular worm gear, thereby causing the panel to rotate. First polarization magnets 2064a, c, e, and g are magnets that have a polarization that is opposite the magnets of the second polarization magnets 2064b, d, f, and h. Electro magnets 2066a and b have a polarization that can be reversed to attract either one of first polarity magnets 2064a, c, e, and g or one of second polarity magnets 2064b, d, f, and h. If in the starting position magnet 2062a is symmetrically located between magnets 2066a and b, which have the opposite polarity attracting magnet 2064a. Changing the polarity of both magnets 2066a and b will repel magnet 2064a, but since magnet 2064a is symmetrically placed between magnets 2066a and b, the ring is in an astable equilibrium, and initially may not move and which way the ring will turn is indeterminate. So instead, the polarization of only one of magnets 2066a and b is initially reversed, depending on the desired direction of rotation. Assuming that the polarization magnet 2066a is reversed, magnet 2064a moves to be adjacent magent 2066b. Then magnet 2066b is reversed, which attracts magnet 2062h and repels magnet 2064a, causing ring 2062 to rotate. The polarity of a magnet refers to which side of the magnet is the north pole and which is the south pole. The North and South poles of the same magnet will always be considered to face away from each other. Two magnets with opposite polarities have their North poles facing in opposite directions from one another and their South poles facing in opposite directions from one another. The magnets may have their axes that connect their respective North poles and South poles to one another facing either perpendicular to parallel to the plane of the ring 2062. In the axes are parallel to the plane of ring 2062, then for two magnets having opposite polarities, one magnet has its North Pole facing the center of the ring 2062 (and its South pole facing the center of ring 2062) and the other magnet has its North pole facing away from the center of ring 2062 (and its South pole facing away form the center of ring 2062).

A First Axis of Rotation

FIG. 20D shows an embodiment of solar generator 1100 having panels 1102a-d, which have been rotated about an axis concentric with circular worm gears 1108a and b, using the motor in the tabs attached to panels 1102a-d.

Collar Gear on Outer Cylinder

FIG. 21 shows an embodiment of a portion 2100 of solar generator 1100. Portion 2100 shows outer cylinder 1104, ground screw 1118a, rings 1120a and b, collar gear 1122, knob 1124, and outer collar 1128. Collar gear 1122 has teeth 2102. In other embodiments portion 2100 may not have all of the elements or features listed and/or may have other elements or features instead of or in addition to those listed.

Outer cylinder 1104, ground screw 1118a, rings 1120a and b, collar gear 1122, knob 1124, and outer collar 1128 were discussed in FIG. 11. Teeth 2102 are used for turning collar gear 1122, thereby turning outer cylinder 1104 and the panels with cylinder 1104. Knob 1124 engages teeth 2102. Collar gear 1122 is located between rings 1120a and b.

FIG. 22 shows an embodiment of a portion 2200 of solar generator 1100. Portion 2100 may include outer cylinder 1104 having channels 1406a-d and collar gear 1122. In other embodiments portion 2200 may not have all of the elements or features listed and/or may have other elements or features instead of or in addition to those listed.

Collar gear 1122 engages channels 1406a-d so that collar gear remains in a fixed position with respect to, and on, outer cylinder 1104.

FIG. 23 shows an embodiment of a portion 2300 of solar generator 1100. Portion 2300 may include collar gear 1122 and knob 1124 having worm gear 2302. In other embodiments portion 2300 may not have all of the elements or features listed and/or may have other elements or features instead of or in addition to those listed.

Worm gear 2302 is attached to knob 1124 and engages collar gear 1122, so that when knob 1124 is turned worm gear 2302 rotates, which turns collar gear 1122, outer cylinder 1104 and everything fixedly attached to outer cylinder 1104. In an embodiment, two electromagnets are located in ground screw 1118a and another two are located in electromagnet 1118b, and a series of magnets having opposite polarities to one another are located in knob 1124 and/or worm gear 2302, which are used to automatically rotate worm gear 2302 (similar to the motor described in conjunction with ring 2062, FIG. 20C), thereby rotating collar gear 1122 and outer cylinder 1104. Alternatively another motor may be used and/or knob 1124 may be rotated manually.

Second Axis of Rotation

FIG. 24 shows an embodiment of solar generator 1100 having panels 1102a-d and outer cylinder 1104 after having been rotated about an axis that outer cylinder 1104 is concentric, using collar gear 1122 and knob 1124. As a result of rotating outer cylinder 1104 panels 1108a-d have also been rotated.

By tracking the Sun constantly, more energy can be collected than stationary photovoltaic panels. Incidentally, this also increases the energy production of the devices by about 40% as a result of always face the sun, giving the maximum surface utilization. Point focus devices require dual axis tracking, both for the daily motion of the Sun and for the seasonal changes which are +/−23 degrees. In addition, in an embodiment, solar generator 1100 has different configurations and/or settings for different latitudes from the equator. For seasonal tracking of the Sun the panel is rotated 23 degrees about a first axis. For tracking the Sun through out the day the panel is rotated 45 degrees about a second axis.

Storage Configuration

FIG. 25 shows another embodiment of solar generator 1100 in configuration 2500, having solar panels 1102a-c (solar panel 1102d is present but not visible in FIG. 25), outer cylinder 1104, secondary mirrors 1112, ground screws 1118a and b having rings 1120a-d, and collar gear 1122, knob 1124, and supports 2510a-d.

Solar panels 1102a-c (solar panel 1102d is present but not visible in FIG. 25), outer cylinder 1104, secondary mirrors 1112, ground screws 1118a and b having rings 1120a-d, and collar gear 1122 were discussed above in conjunction with FIG. 11. Supports 2510a-d are similar to, and serve the same function as, supports 1110a-d. However, supports 2510a-d do not crisscross one another, whereas supports 1110a and b crisscross one another forming an X, and supports 1110c and d also crisscross one another forming an X.

Configuration 2500 may be useful for storing solar generator 1100 when solar generator 1100 is not in use. In configuration 2500, outer cylinder has been rotated, via collar gear 1122 and knob 1124 (which are located between rings 1120a and b), 180 degrees until supports 2510a-d and secondary mirrors 1112 are below the solar generator 1100 on the same side as ground screws 1118a and b, and panels 1102a and b are upside down.

Support Structure

FIG. 26 shows an embodiment of a support 2600 that may be used for supports 1204a and b and/or 1110a-d, which may include mesh 2602, rounded endings 2604a-c, elongated panels 2606a-c, and center 2608. In other embodiments support 2600 may not have all of the elements or features listed and/or may have other elements or features instead of or in addition to those listed.

Mesh 2602 includes crisscrossing lines that wrap around the rest support 2600. Round endings 2604a-c are placed at the ending of portions of support 2600. Mesh 2602 rests on round ending 2604a-c so that mesh 2602 is less likely to wear as compared to were mesh 2602 resting on sharp corners. Elongated panel 2606a-c extend outwards from a central point and are equally spaced form one another. Round ends 2604a-c are placed on the ends of elongated panels 2606a-c and support the mesh 2602, via rounded ends 2604a-c, respectively. Center 2608 is the central point where elongated panels 2606a-c meet. The combination of rounded endings 2604a-c, elongated panels 2606a-c, and center 2608 may be formed by extrusion. Although the embodiment of FIG. 26 shows only three elongated panels any number greater than three may be used. For example, there may be four elongated panel forming a plus sign cross section.

In an embodiment, support 2600 is a captive column. Captive columns are described in U.S. Pat. No. 3,501,880, which is incorporated herein by reference.

Heat Storage

FIG. 27 shows a representation of an embodiment of a heat storage system 2700, which may include inlet pipe 2702, inlet valve 2704, inlet fan 2706, insulation 2708, container 2710, granular or fibrous material 2712, outlet fan 2714, outlet valve 2716 and outlet pipe 2714. In other embodiments heat storage system 2700 may not have all of the elements or features listed and/or may have other elements or features instead of or in addition to those listed.

Any of the solar generators disclosed in this specification may be connected to heat storage system 2700, which stores heat generated by a solar generator for later use. Inlet pipe 2702 brings a heated fluid from a solar generator to a storage area. Inlet pipe 2702 may be connected to one end of pipe 1802 (FIG. 2), for example. Inlet valve 2704 determines whether the fluid is allowed to enter the storage area. Valve 2704 may have one setting that allows fluid from the inlet pipe to enter or exit the storage area and a second setting that does not allow fluid in or out via inlet pipe 2074. Inlet turbine 2706 may be a fan if the fluid is a gas, for example, and may be used to pump the fluid into the storage area. Container 2708 is optional and stores a heat storage material. The heated fluid from the solar generator may be pumped into container 2708 to heat the heat storage material. Insulation 2710 insulates container 2708. Insulation 2708 may be a poly urethane material (e.g., Styrofoam®), fiber glass, earth, or another insulator. In an embodiment container 2708 is placed under ground or replaced with a hole in the ground and the ground is insulator 2710. Granular or fibrous material 2012 is a heat storage material, which may include pebbles and/or rockwool. In an embodiment, granular or fibrous material 2012 has a large heat capacity so that a lot of heat may be stored and retained. The heat capacity of the fibrous or granular material is significantly higher than air, and maybe comparable to pebbles or rockwool. In an embodiment, granular or fibrous material 2012 has a large surface area, so that heat may be absorbed and/or released relatively quickly when desired. Outlet fan 2714 may pump air heated by the heat storage material out of container 2708 or out of the ground. Outlet valve 2716 determines whether fluid may enter or leave container 2708 or the ground via an outlet pipe. Outlet pipe 2714 carries air heated to a location for use, such as to a home for heating or converting to another form of energy, such as electricity. In one mode of operation, both inlet valve 2704 and outlet valve 2716 are open, and fluid flows through container 2710. If the temperature of the fluid is higher than the temperature of granular or fibrous material 2712, heat is stored in granular or fibrous material 2712 by heating granular or fibrous material 2712. If the temperature of the fluid is lower than the temperature of granular or fibrous material 2712, heat is released from granular or fibrous material 2712, and granular or fibrous material 2712 is cooled, while the fluid is heated for use. In this mode of operation, only one fan is necessary.

In another mode of operation, during the day time while the sun is shining, inlet valve is open and inlet fan is turned on, while outlet fan is turned off and outlet valve is shut closed. As a result, heated fluid from the solar generator is pumped into container. Since there is no place for the fluid to escape, the fluid is compressed while heating granular or fibrous material. As a result of the compression, the temperature of the fluid increases. Thus granular or fibrous material may be heated to a temperature that is higher than the temperature of the fluid in the solar generator. In the evening or at another time when it is desired to use some of the stored energy, outlet valve is open and outlet fan is turned on so as to cool granular or fibrous material and heat out going fluid. While removing heat from granular or fibrous material, inlet valve may be either open or closed and inlet fan may be either on or off.

Thus, for heat applications, the superheated air can be directed into underground storage (or an insulated container) filled with 3-4 cm pebbles. In an embodiment, storage system 2700 is extremely reliable, non-toxic and low-cost and can store the heat with little loss over several days. When the energy is needed, a fan blows the superheated air out of this storage. This makes solar energy available 24/7 and even during cloudy periods. The size of the solar array versus the size of the pebble storage decides the duration of the energy backup function. Storing heat energy is vastly less costly and complex than storing electricity and storing heat energy also allows the generator to store energy form other sources, such as bio energy.

Control Circuit

FIG. 28 shows a block diagram of the control circuit 2800 for controlling solar generator 1100, which may include timer system 2802, sensor system 2804, memory system 2806, processor system 2808, interface system 2810, and power supply 2812, which may include AC/DC converter 2816, battery 2818, and ground 2820. Control circuit 2800 may also power line 2822 and communication line 2824. In other embodiments control circuit 2800 may not have all of the elements or features listed and/or may have other elements or features instead of or in addition to those listed

Control circuit 2800 may have a gyro sensor which in combination with a clock may be used for determining the orientation of the solar panels of the solar generator. Control circuit 2800 may also be connected to the heat sensors which monitor the actual individual beam position. The gyro sensors are either located between the secondary mirror and the receiver or is integrated in the secondary mirror. Control circuit 2800 may also have either supercapacitors or a rechargeable 9V battery to store enough energy to return the solar generator back to the middle position or a storage position awaiting the morning sun to complete the track. The circuit board 2800 is made in plastic using the Circuits-In-Plastic method (CIP), which is highly environmentally safe, cost-effective, and water-proof.

Timer system 2802 may keep track of the amount of time that has passed. Sensor system 2804 may include a daytime sensor 1126 (FIG. 11), which may be a light sensor that determines whether the Sun is shining. Sensor system 2804 may include one or more accelerometers and/or gyros to determine the direction that panels 1102a-d are facing.

Memory system 2806 stores machine instructions for determining what direction to orient panels 1102a-d. Memory 2806 may include a table of the correct daily orientation for each day of the year. Memory 2806 may include one or more equations that determine the correct orientation for a given time and day. Memory system 2806 may also store user settings and/or intermediate computational results. Memory system 2806 may include the cache of the processor system, short term and/or long term (e.g., volatile and nonvolatile memory).

Processor system 2808 implements the machine instructions stored in memory system 2806. Processor systems 2808 may include one or more processors. Timer system 2802 may be part of processor system 2808 or may be a separate system.

Processor systems 2808 receives signals from sensor system 2804 and/or timer system 2802, and, optionally, based on input from the timer system 2804 and/or sensor system 2802 a determination is made whether panels 1102a-d are properly positioned, and if it is determined that panels 1102a-d are not positioned properly, processor system 2808 sends signals to magnetic motors to move panels 1102a-d to a better position for collecting sunlight. In another embodiment, without making any explicit determination regarding whether panels 1102a-d are properly positioned, processor system 2808 sends signals to magnetic motors to update panels 1102a-d to a particular position (which is assumed to be or projected to be the proper position) for collecting sunlight. The proper position of solar generator may be determined by the time of year, geographic location, and/or the locations of clouds in the sky. In one embodiment the position of panels 1102a-d is rotated slightly each day about an axis that points East-West, according to the day of the year. Additionally, or alternatively, the position of panels 1102a-d is rotated gradually throughout each day each day about an axis that points North-South, according to the time of day.

Interface system 2810 may include an on/off switch and/or may include other settings for inputting the longitude and/or latitude of the solar generator, the date and/or the time of day.

Power supply 2812 provides power to the rest of control circuit 2800. AC/DC converter 2816 converts DC electricity to AC electricity and supplies the AC electricity to the rest of control circuit 2800. Battery 2816 supplies DC electricity to AC/DC converter 2816 for conversion to AC electricity. Ground 2820 is the ground for control circuit 2800.

Power line 2822 carries AC power to timer system 2802, sensor system 2804, memory system 2806, processor system 2808, and interface system 2810. Power line 2822 may include two wires to complete a circuit. Communication line 2824 is used by timer system 2802, sensor system 2804, memory system 2806, processor system 2808, interface system 2810 to communicate with one another. For example, processor system 2802 may retrieve, store data, and retrieve program instructions via communication line 2814 from memory system 2806. Processor system 2802 may receive signals from, and send signals to timer system 2802, sensor system 2804, and interface system 2810, via communication line 2814. Processor system 2802 may cause signals from timer system 2802, sensor system 2804, and/or interface system 2810 to be stored in memory system 2806, via communication line 2814.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A system comprising:
at least one panel having at least an array of flat mirrors; and
the flat mirrors of the array being angled to direct light to one or more locations,
each location having at least two flat mirrors of the array directing light to each of the one or more locations; and
each flat mirror of the array directing light to a location that another flat mirror also direct light.

2. The system of claim 1, wherein the one or more locations form a single focal region.

3. The system of claim 1, wherein the one or more locations is a single focal point.

4. The system of claim 1, the at least one panel forming a polyhedral mirror.

5. The system of claim 1, the at least one panel including a multiplicity if panels, the system further comprising
a surface for receiving light;
a cylinder in which the surface for receiving light is located;
the multiplicity of panels being attached to the cylinder,
the multiplicity of panels being angled to direct light into the cylinder and onto the surface for receiving light.

6. The system of claim 5 further comprising only two legs that support the system.

7. The system of claim 5 further comprising two legs that support the system, each leg having threads for screwing the leg into the ground.

8. The system of claim 7, each leg having at least one opening contoured for accepting the cylinder.

9. The system of claim 8, the cylinder being rotatably attached to the two legs, each leg being connected via the opening.

10. The system of claim 9, the panels being attached to the cylinder such that rotating the cylinder changes the orientation of the panels.

11. The system of claim 9, at least one of the two legs having a motor attached for rotating the cylinder.

12. The system of claim 11 further comprising a gear fixedly attached to the cylinder, the motor rotates the gear, which causes the gear to rotate.

13. The system of claim 1, further comprising a secondary mirror system; the secondary mirror system directing light from the panel into a hole in the cylinder and onto the surface for receiving light.

14. The system of claim 5, further comprising at least one circular worm gear fixedly attached to the cylinder.

15. The system of claim 14, further comprising at least one motor fixedly attached to the at least one panel;
the at least one panel movably attached to the at least one circular worm gear; and
the motor engaging the worm gear, so that the at least one motor causes the at least one panel to move on the circular worm gear.

16. The system of claim 5, the cylinder being an outer a cylinder, the outer system having a hole;
the system further comprising an inner cylinder within the outer cylinder, the inner cylinder having a hole that is aligned with the hole of the outer cylinder;
the surface for receiving light being located within the inner cylinder at the hole of the inner cylinder; and
light from the at least one panel that is directed into the outer cylinder is directed through the hole of the outer cylinder and the hole of the inner cylinder and onto the surface for receiving light.

17. The system of claim 5 the cylinder being an outer a cylinder, the outer system having a hole;
the system further comprising:
an inner cylinder within the outer cylinder, the inner cylinder having a hole that is aligned with the hole of the outer cylinder;
a secondary mirror system; the secondary mirror system directing light from the panel into a hole in the cylinder and onto the surface for receiving light;
the surface for receiving light being located within the inner cylinder at the hole of the inner cylinder; light from the at least one panel that is directed into the outer cylinder is directed through the hole of the outer cylinder and the hole of the inner cylinder and onto the surface for receiving light;
only two legs that support the system,
each leg having threads for screwing the leg into the ground,
each leg having at least one opening contoured for accepting the cylinder, and
the cylinder being rotatably attached to the two legs to rotate about a first axis, each leg being connected via the opening;
at least one motor attached to at least one of the two legs;
a gear fixedly attached to the cylinder, the at least one motor rotates the gear, which causes the gear to rotate; the panels being attached to the cylinder such that rotating the cylinder changes the orientation of the panels by rotating the panels about a first axis;
at least one circular worm gear fixedly attached to the cylinder;
at least second motor fixedly attached to the at least one panel; and
the at least one panel movably attached to the at least one circular worm gear; and
the motor engaging the worm gear, such that the at least one motor causes the at least one panel to move about a second axis that is perpendicular to the first axis, the panel moving on the circular worm gear.

18. A method comprising:
collecting light with at least one panel having an array of flat mirrors;
directing the light, via an angling of the mirrors of the array, one or more locations.
the flat mirrors of the array being angled to direct light to one or more locations,
each location having at least two flat mirrors of the array directing light to each of the one or more locations; and
each flat mirror of the array directing light to a location that another flat mirror also direct light.

19. The method of claim 18, wherein the one or more locations form a single focal region.

20. The method of claim 18, wherein the one or more locations is a single focal point.

21. The method of claim 18, the light being directed to form a polyhedral light distribution.
